(19) United States
(12) Patent Application Publication
(10) Pub. No.: US 2015/0135920 A1
(43) Pub. Date: May 21, 2015

(54) DEVICES, METHODS, AND SYSTEMS FOR COLLECTION OF INSECT SALIVARY GLANDS

(71) Applicant: TOKITAE LLC, Bellevue, WA (US)

(72) Inventors: Jennifer Ezu Hu, Seattle, WA (US); Jerry W. Lee, Kirkland, WA (US); Emma Rae Mullen, Seattle, WA (US); David Keith Piech, Seattle, WA (US); Matthew F. Rosen, Seattle, WA (US)

(73) Assignee: TOKITAE LLC, Bellevue, WA (US)

(21) Appl. No.: 14/086,631

(22) Filed: Nov. 21, 2013

(51) Int. Cl. B26D 5/00; B26F 3/00

(52) U.S. Cl. CPC B26D 5/007; B26F 3/004
USPC 83/73; 173/4

(57) ABSTRACT

The present disclosure relates to devices, methods and systems that may be used to collect insect salivary glands. In some embodiments, the devices, methods, and systems may be used to collect salivary glands from a mosquito.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### Priority Applications

None.

### Related Applications

None.

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### SUMMARY

In one aspect, a device includes, but is not limited to, two or more fluid reservoirs that are operably coupled to allow fluid flow between the two or more fluid reservoirs through one or more hydrodynamic shear members, two or more fluid displacement members that are each individually moveably coupled within each of the two or more fluid reservoirs, one or more drive mechanisms that are operably coupled to each of the two or more fluid displacement members and configured to move each of the two or more operably coupled fluid displacement members in coordinated opposition to each other within each of the two or more fluid reservoirs, and one or more control units that are configured to control operation of the one or more drive mechanisms. In some embodiments, a device may optionally include, one or more imaging apparatuses. In addition to the foregoing, other device aspects are described in the claims, drawings, and text forming a part of the present disclosure.

In one aspect, a system includes, but is not limited to, circuitry configured to acquire one or more images of one or more insects that are being dissected by one or more hydrodynamic shear forces within a fluid, circuitry configured to analyze the one or more images of the one or more insects, and circuitry configured to control one or more fluid propulsion modules in response to the circuitry configured to analyze the one or more images of the one or more insects. In addition to the foregoing, other system aspects are described in the claims, drawings, and text forming a part of the present disclosure.

In one aspect, a system includes, but is not limited to, means for acquiring one or more images of one or more insects that are being dissected by one or more hydrodynamic shear forces within a fluid, means for analyzing the one or more images of the one or more insects, and means for controlling one or more fluid propulsion modules in response to the means for analyzing the one or more images of the one or more insects.

In one aspect, a system includes, but is not limited to, a computer program product including at least one non-transitory computer readable media including at least: one or more instructions to acquire one or more images of one or more insects that are being dissected by one or more hydrodynamic shear forces within a fluid, one or more instructions to analyze the one or more images of the one or more insects to produce an analysis of the one or more images of the one or more insects, and one or more instructions to control one or more fluid propulsion modules in response to the analysis of the one or more images of the one or more insects. In addition to the foregoing, other system aspects are described in the claims, drawings, and text forming a part of the present disclosure.

In one aspect, a method includes, but is not limited to, dissecting at least one insect by subjecting the at least one insect to at least one hydrodynamic shear force to produce at least one headless thorax portion from the insect, compressing the at least one headless thorax portion to extrude at least one salivary gland from the at least one headless thorax portion, and collecting the at least one salivary gland. In addition to the foregoing, other method aspects are described in the claims, drawings, and text forming a part of the present disclosure.

In one or more various aspects, means include but are not limited to circuitry and/or programming for effecting the herein referenced functional aspects; the circuitry and/or programming can be virtually any combination of hardware, software, and/or firmware configured to effect the herein referenced functional aspects depending upon the design choices of the system designer. In addition to the foregoing, other system aspects means are described in the claims, drawings, and/or text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein referenced method aspects depending upon the design choices of the system designer. In addition to the foregoing, other system aspects are described in the claims, drawings, and/or text forming a part of the present application.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

FIG. 1 illustrates an example system 100 in which embodiments may be implemented.

FIG. 2 illustrates example components of system 100 in which embodiments may be implemented.

FIG. 3 illustrates example components of system 100 in which embodiments may be implemented.

FIG. 4 illustrates a side, partial cross-sectional view of an example device 400 in which embodiments may be implemented.

FIG. 5 illustrates a side, partial cross-sectional view of an example device 500 in which embodiments may be implemented.

FIG. 6 illustrates a side, partial cross-sectional view of an example hydrodynamic shear member that operably coupled to two syringes.

FIG. 7 illustrates a side, partial cross-sectional view of an example hydrodynamic shear member that operably coupled to two syringes.

FIG. 8 illustrates a top, partial cross-sectional view of example system 800 in which embodiments may be implemented.

FIG. 9 illustrates a top, partial cross-sectional view of example system 900 in which embodiments may be implemented.

FIG. 10 illustrates a side, partial cross-sectional view of an example system 1000 in which embodiments may be implemented.

FIG. 11 illustrates a side, partial cross-sectional view of an example system 1100 in which embodiments may be implemented.

FIG. 12 illustrates a side, partial cross-sectional view of an example system 1200 in which embodiments may be implemented.

FIG. 13 illustrates a side, partial cross-sectional view of an example system 1300 in which embodiments may be implemented.

FIG. 14 illustrates a side, partial cross-sectional view of an example device 1400 in which embodiments may be implemented.

FIG. 15 illustrates a side, partial cross-sectional view of an example device 1500 in which embodiments may be implemented.

FIG. 16 illustrates a side, partial cross-sectional view of an example device 1600 in which embodiments may be implemented.

FIG. 17 illustrates a side, partial cross-sectional view of an example device 1700 in which embodiments may be implemented.

FIG. 18 illustrates a side view of an example device 1800 in which embodiments may be implemented.

FIG. 19 illustrates a side view of an example device 1900 in which embodiments may be implemented.

FIG. 20 illustrates a side view of an example device 2000 in which embodiments may be implemented.

FIG. 21 illustrates a side view of an example device 2100 in which embodiments may be implemented.

FIG. 22 illustrates a cross-sectional top view of an example device 2200 in which embodiments may be implemented.

FIG. 23 illustrates a cross-sectional top view of an example device 2300 in which embodiments may be implemented.

FIG. 24 illustrates a cross-sectional top view of an example device 2400 in which embodiments may be implemented.

FIG. 25 illustrates an example operational flow 2500 in which embodiments may be implemented.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

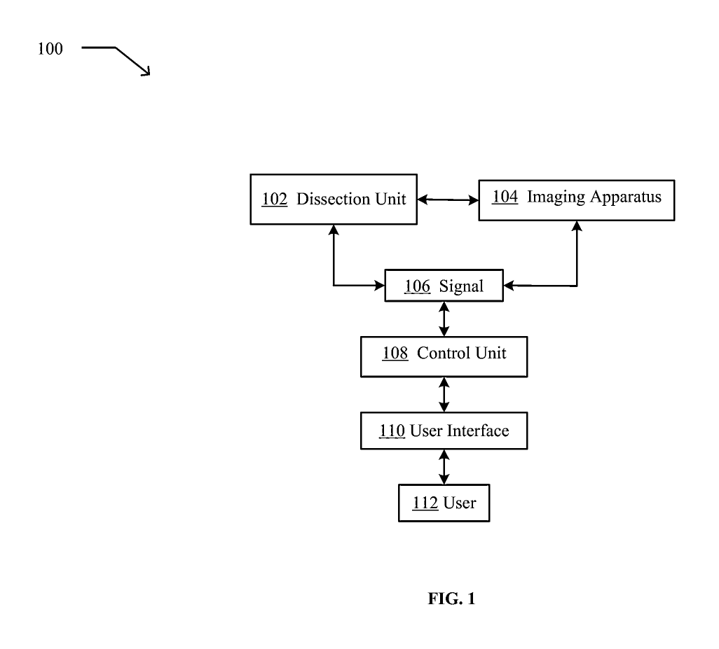

FIG. 1 illustrates an example system 100 in which embodiments may be implemented. The system 100 may include one or more dissection units 102. The system 100 may include one or more imaging apparatuses 104. The system 100 may include one or more signals 106. The system 100 may include one or more control units 108. The system 100 may include one or more user interfaces 110. The system 100 may be used by one or more users 112.

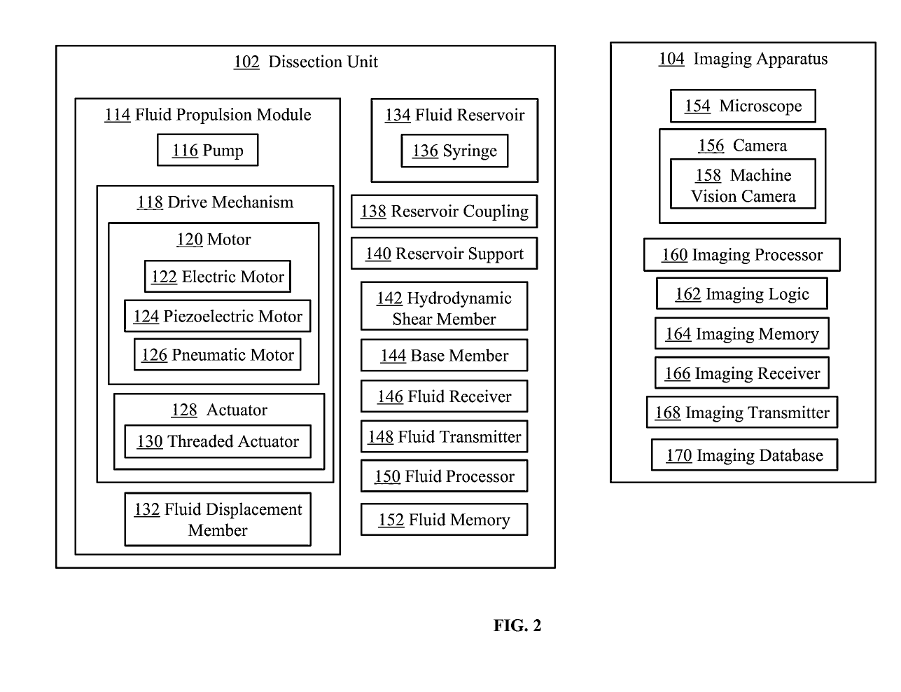

FIG. 2 illustrates example embodiments of components of system 100. The illustrated components include a dissection unit 102 and an imaging apparatus 104.

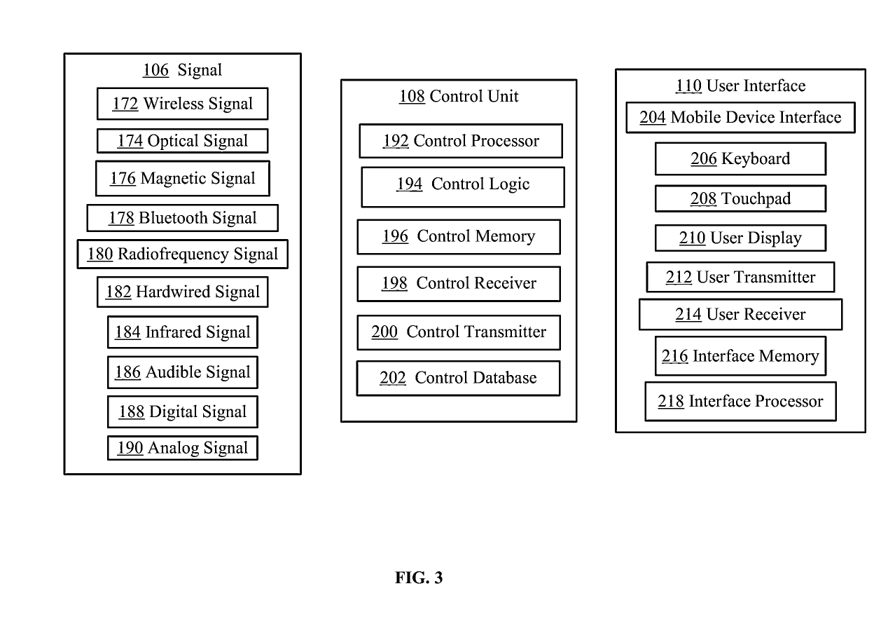

FIG. 3 illustrates example embodiments of components of system 100. The illustrated components include a signal 106, a control unit 108, and a user interface 110.

### Dissection Unit

In some embodiments, system 100 may include one or more dissection units 102. A dissection unit 102 may be configured in numerous ways. In some embodiments, a dissection unit 102 may include one or more fluid propulsion modules 114. In some embodiments, a dissection unit 102 may include one or more fluid displacement members 132. In some embodiments, a dissection unit 102 may include one or more fluid reservoirs 134. In some embodiments, a dissection unit 102 may include one or more reservoir couplings 138. In some embodiments, a dissection unit 102 may include one or more reservoir supports 140. In some embodiments, a dissection unit 102 may include one or more hydrodynamic shear members 142. In some embodiments, a dissection unit 102 may include one or more base members 144. In some embodiments, a dissection unit 102 may include one or more fluid receivers 146. In some embodiments, a dissection unit 102 may include one or more fluid transmitters 148. In some embodiments, a dissection unit 102 may include one or more fluid processors 150. In some embodiments, a dissection unit 102 may include fluid memory 152.

In some embodiments, a dissection unit 102 may include one or more fluid reservoirs 134. Fluid reservoirs 134 may be configured in numerous ways. For example, in some embodiments, a fluid reservoir 134 may be configured as a syringe barrel. In some embodiments, a fluid reservoir 134 may be configured as an open ended cylinder. In some embodiments, a fluid reservoir 134 may be configured as a closed ended cylinder. In some embodiments, a dissection unit 102 may include two or more fluid reservoirs 134 that are fluidly coupled. In some embodiments, a dissection unit 102 may include three or more fluid reservoirs 134 that are fluidly coupled. In some embodiments, a dissection unit 102 may include four or more fluid reservoirs 134 that are fluidly coupled. Accordingly, in some embodiments, a dissection unit 102 may include multiple fluid reservoirs 134 that are fluidly coupled. In some embodiments, two or more fluid reservoirs 134 may be fluidly coupled through one or more hydrodynamic shear members 142. In some embodiments, three or more fluid reservoirs 134 may be fluidly coupled through one or more hydrodynamic shear members 142. In some embodiments, four or more fluid reservoirs 134 may be fluidly coupled through one or more hydrodynamic shear members 142. Accordingly, in some embodiments, multiple fluid reservoirs 134 may be fluidly coupled through one or more hydrodynamic shear members 142.

In some embodiments, a fluid reservoir 134 may be configured to receive a fluid displacement member 132. A fluid displacement member 132 may be configured in numerous ways. In some embodiments, a fluid displacement member 132 may be configured for insertion into a fluid reservoir 134 such that the fluid displacement member 132 may be moveably coupled with the fluid reservoir 134. In some embodiments, a fluid displacement member 132 may be threaded and configured for insertion into a threaded fluid reservoir 134 that is configured to receive the threaded fluid displacement member 132. In some embodiments, a fluid displacement member 132 may be configured as a plunger. In some embodiments, a fluid displacement member 132 may be configured as a syringe plunger. In some embodiments, a fluid displacement member 132 may be configured as a bladder that may be inflated or deflated. Accordingly, in some embodiments, a dissection unit 102 may include two or more fluid reservoirs 134 that are each operably coupled with a fluid displacement member 132. In some embodiments, a dissection unit 102 may include one or more drive mechanisms 118 that are operably coupled with one or more fluid displacement members 132. In some embodiments, one or more drive mechanisms 118 may be configured to cause one or more fluid displacement members 132 to move into and/or out of one or more operably coupled fluid reservoirs 134 in which the one or more fluid displacement members 132 are moveably coupled.

Accordingly, in some embodiments, operation of one or more drive mechanisms 118 will cause fluid to be expelled from one or more fluid reservoirs 134. In some embodiments, operation of one or more drive mechanisms 118 will cause fluid to be drawn into one or more fluid reservoirs 134. In some embodiments, operation of one or more drive mechanisms 118 will cause fluid to be expelled from one or more fluid reservoirs 134 and drawn into one or more different fluid reservoirs 134. Accordingly, in some embodiments, operation of one or more drive mechanisms 118 may cause fluid contained within a fluid reservoir 134 to be pushed through one or more operably coupled hydrodynamic shear members 142. In some embodiments, operation of one or more drive mechanisms 118 may cause fluid contained within a fluid reservoir 134 to be drawn through one or more operably coupled hydrodynamic shear members 142. In some embodiments, operation of one or more drive mechanisms 118 may cause fluid contained within a fluid reservoir 134 to be both pushed through one or more operably coupled hydrodynamic shear members 142 and drawn through the one or more operably coupled hydrodynamic shear members 142 into another fluid reservoir 134.

In some embodiments, a dissection unit 102 may include one or more fluid propulsion modules 114 that may be configured in numerous ways. For example, in some embodiments, a fluid propulsion module 114 may include one or more pumps 116. A fluid propulsion module 114 may include numerous types of pumps 116. Examples of such pumps 116 include, but are not limited to, vacuum pumps, suction pumps, peristaltic pumps, piston pumps, and the like. In some embodiments, a fluid propulsion module 114 may include a drive mechanism 118 that is operably coupled to a fluid displacement member 132. A drive mechanism 118 may be configured in numerous ways. For example, in some embodiments, a drive mechanism 118 may be configured as a motor 120 that is operably coupled to a fluid displacement member 132 through an actuator 128. In some embodiments, a drive mechanism 118 may be configured as a spring that is operably coupled to a fluid displacement member 132. In some embodiments, a drive mechanism 118 may be configured as an elastomeric member (e.g., rubber band) that is operably coupled to a fluid displacement member 132. A drive mechanism 118 may include numerous types of motors 120. Examples of such motors 120 include, but are not limited to, electric motors 122, piezoelectric motors 124, pneumatic motors 126, and the like. A drive mechanism 118 may include numerous types of actuators 128. Examples of such actuators 128 include, but are not limited to, threaded actuators 130, crankshaft-type actuators, pushrod actuators, and the like. Accordingly, in some embodiments, a motor 120 may advance a threaded actuator 130 by turning the threaded actuator 130 in a screw-type mechanism. In some embodiments, a motor 120 may advance a crankshaft-type actuator 128 by turning the crankshaft-type actuator 128 to cause one or more operably coupled fluid displacement members 132 to move within one or more fluid reservoirs 134. A fluid propulsion module 114 may include numerous types of fluid displacement members 132. Examples of such fluid displacement members 132 include, but are not limited to, plungers, threaded fluid displacement members 132, syringe plungers, and the like.

In some embodiments, a dissection unit 102 may include one or more base members 144. In some embodiments, a dissection unit 102 may include one or more reservoir supports 140. In some embodiments, a dissection unit 102 may include one or more base members 144 that are operably coupled to one or more reservoir supports 140. Accordingly, in some embodiments, a dissection unit 102 may include one or more base members 144 that are operably coupled to one or more fluid reservoirs 134 through one or more reservoir supports 140. In some embodiments, a dissection unit 102 may include one or more reservoir couplings 138 that serve to operably couple two or more fluid reservoirs 134. For example, in some embodiments, a reservoir coupling 138 may be configured as a luer lock connector. In some embodiments, a reservoir coupling 138 may be configured as a friction fitting.

In some embodiments, a dissection unit 102 may include one or more hydrodynamic shear members 142. Hydrodynamic shear members 142 may be configured in numerous ways. For example, in some embodiments, a hydrodynamic shear member 142 may be configured as a constriction through which fluid flows that will create hydrodynamic shear force. For example, in some embodiments, a hydrodynamic shear member 142 may be configured as a constriction through which fluid flows that will create tensile force. For example, in some embodiments, a hydrodynamic shear member 142 may be configured as a luer lock connector that connects two syringes 136 together and creates a constriction region between the two syringes 136. In some embodiments, a hydrodynamic shear member 142 may be configured as a hydrodynamic cavitation device (e.g., McGuire et al., Hydrodynamic cavitation device, Published U.S. Patent Application: 20130088935, herein incorporated by reference). For example, in some embodiments, a hydrodynamic shear member 142 may be configured as a tube having one or more protrusions that extend inward with respect to the longitudinal axis of fluid flow through the tube.

In some embodiments, a dissection unit 102 may include one or more fluid receivers 146. In some embodiments, a dissection unit 102 may include one or more fluid transmitters 148. In some embodiments, a dissection unit 102 may include one or more fluid processors 150. In some embodiments, a dissection unit 102 may include fluid memory 152. Accordingly, in some embodiments, a dissection unit 102 may receive one or more signals 106. In some embodiments, a dissection unit 102 may transmit one or more signals 106. In some embodiments, a dissection unit 102 may process one or more signals 106. In some embodiments, a dissection unit 102 may store data. Accordingly, in some embodiments, a dissection unit 102 may receive one or more signals 106 that are transmitted from one or more imaging apparatuses 104. In some embodiments, a dissection unit 102 may receive one or more signals 106 that are transmitted from one or more control units 108. In some embodiments, a dissection unit 102 may receive one or more signals 106 that are transmitted from one or more user interfaces 110. In some embodiments, a dissection unit 102 may receive one or more signals 106 that instruct the dissection unit 102 to control the operation of one or more fluid propulsion modules 114. For example, in some embodiments, one or more signals 106 may include instructions to increase the rate at which one or more pumps 116 are operating. In some embodiments, one or more signals 106 may include instructions to decrease the rate at which one or more pumps 116 are operating. In some embodiments, one or more signals 106 may include instruction to increase the rate at which one or more motors 120 are operating. In some embodiments, one or more signals 106 may include instruction to decrease the rate at which one or more motors 120 are operating. In some embodiments, a dissection unit 102 may transmit one or more signals 106 that are received by one or more control units 108. In some embodiments, a dissection unit 102 may transmit one or more signals 106 that are received by one or more user interfaces 110.

In some embodiments, one or more such signals 106 may include information related to the operation of one or more fluid propulsion modules 114. For example, in some embodiments, one or more signals 106 may include information related to the level of operation of one or more pumps 116. In some embodiments, one or more such signals 106 may include information related to the level of operation of one or more motors 120. In some embodiments, a dissection unit 102 may receive one or more signals 106 that are then processed by the dissection unit 102. In some embodiments, a dissection unit 102 may receive one or more signals 106 that include information related to one or more images of one or more insects that are included within the dissection unit 102. For example, in some embodiments, a dissection unit 102 may receive one or more signals 106 that include information related to one or more images of one or more mosquitos that are being dissected within the dissection unit 102. Accordingly, in some embodiments, a dissection unit 102 may process one or more such signals 106 to determine whether to continue operating the dissection unit 102 or to stop operating the dissection unit 102. In some embodiments, a dissection unit 102 may process one or more such signals 106 to determine whether to increase, decrease, or maintain the level of operation of one or more fluid propulsion modules 114. For example, in some embodiments, a dissection unit 102 may process one or more signals 106 that include information related to one or more images of one or more mosquitos that are being dissected in the dissection unit 102 and increase the level of operation of one or more motors 120 to increase the level of hydrodynamic shear force applied to the one or more mosquitos. Accordingly, in some embodiments, a dissection unit 102 may operate in response to the extent of dissection of one or more insects within the dissection unit 102.

In some embodiments, a dissection unit 102 may be user controlled. In some embodiments, a user 112 may utilize a user interface 110 to control the operation of one or more dissection units 102. For example, in some embodiments, one or more imaging apparatuses 104 may acquire one or more images of one or more insects that are being dissected in a dissection unit 102. The one or more imaging apparatuses 104 may then transmit one or more signals 106 that include information related to the one or more images that are received by one or more user interfaces 110. A user 112 may view the one or more images on the user interface 110 and then cause the user interface 110 to transmit one or more signals 106 that control the operation of the one or more dissection units 102 that are in the process of dissecting the one or more insects. In some embodiments, a user 112 may utilize a user interface 110 to transmit one or more signals 106 that are received by one or more control units 108. In some embodiments, one or more control units 108 may transmit one or more signals 106 that are received by one or more dissection units 102. In some embodiments, such signals 106 may instruct the one or more dissection units 102 to control the operation of one or more fluid propulsion modules 114. For example, one or more such signals 106 may instruct the one or more dissection units 102 to increase, decrease, or maintain the level of operation of one or more fluid propulsion modules 114.

In some embodiments, a dissection unit 102 may include fluid memory 152 that includes information related to one or more insects. A dissection unit may include numerous types of memory. Examples of types of memory include, but are not limited to, flash memory, electronic memory, disk storage, random access memory, virtual memory, and the like. In some embodiments, fluid memory 152 may include information related to one or more images of one or more insects. For example, in some embodiments, fluid memory 152 may include one or more images of one or more mosquitos (or any other suitable insects) that are in varying states of dissection. In some such images a mosquito may lack one or both wings, one or more legs, a head portion, an abdominal portion, or any combination thereof. Accordingly, in some embodiments, a dissection unit 102 may process information by comparison to one or more stored images of one or more insects. For example, in some embodiments, a dissection unit 102 may compare image information related to one or more mosquitos being dissected in the dissection unit 102 to one or more images of dissected mosquitos in fluid memory 152 and determine the extent to which the mosquitos in the dissection unit 102 are dissected. In some embodiments, such a determination may be used to control the operation of the dissection unit 102.

### Imaging Apparatus

In some embodiments, system 100 may include one or more imaging apparatuses 104. Accordingly, in some embodiments, system 100 may utilize one or more imaging apparatuses 104 to acquire one or more images. An imaging apparatus 104 may include numerous types of imaging devices. Examples of such imaging devices include, but are not limited to, microscopes 154, cameras 156, machine vision cameras 158, and the like. In some embodiments, an imaging apparatus 104 may include one or more imaging processors 160. In some embodiments, an imaging apparatus 104 may include one or more imaging receivers 166. In some embodiments, an imaging apparatus 104 may include one or more imaging transmitters 168. In some embodiments, an imaging apparatus 104 may include imaging logic 162. In some embodiments, an imaging apparatus 104 may include imaging memory 164. In some embodiments, an imaging apparatus 104 may include one or more imaging databases 170.

In some embodiments, an imaging apparatus 104 may receive one or more signals 106. In some embodiments, an imaging apparatus 104 may transmit one or more signals 106. In some embodiments, an imaging apparatus 104 may process one or more signals 106. For example, in some embodiments, an imaging apparatus 104 may acquire one or more images of one or more insects that are contained within a dissection unit 102. The imaging apparatus 104 may then transmit one or more signals 106 that include the one or more images. In some embodiments, the one or more signals 106 may be received by one or more dissection units 102. In some embodiments, the one or more signals 106 may be received by one or more control units 108. In some embodiments, the one or more signals 106 may be received by one or more user interfaces 110. In some embodiments, an imaging apparatus 104 may receive one or more signals 106. For example, in some embodiments, an imaging apparatus 104 may receive one or more signals 106 that instruct the imaging apparatus 104 to acquire one or more images. In some embodiments, an imaging apparatus 104 may receive one or more signals 106 that are transmitted by one or more control units 108. In some embodiments, an imaging apparatus 104 may receive one or more signals 106 that are transmitted by one or more user interfaces 110.

In some embodiments, an imaging apparatus 104 may process one or more signals 106. In some embodiments, an imaging apparatus 104 may acquire one or more images and then compare the one or more acquired images to one or more stored images. For example, in some embodiments, an imaging apparatus 104 may acquire one or more images of one or more mosquitos that are being dissected in a dissection unit 102. The imaging apparatus 104 may then compare the one or more acquired images to one or more images of dissected mosquitos that are stored in an imaging database 170. The imaging apparatus 104 may then determine the extent to which the mosquitos in the dissection unit 102 have been dissected. In some embodiments, an imaging apparatus 104 may then transmit one or more signals 106 that instruct one or more dissection units how to operate one or more fluid propulsion modules 114. For example, in some embodiments, an imaging apparatus 104 may transmit one or more signals 106 instructing one or more dissection units to increase, decrease, or maintain the level of operation of one or more motors 120.

### Signal

Numerous types of signals 106 may be utilized within system 100. Examples of such signals 106 include, but are not limited to, wireless signals 172, optical signals 174, magnetic signals 176, Bluetooth signals 178, radiofrequency signals 180, hardwired signals 182, infrared signals 184, audible signals 186, digital signals 188, analog signals 190, and the like.

### Control Unit

In some embodiments, system 100 may include one or more control units 108. In some embodiments, a control unit 108 may include one or more control receivers 198. Accordingly, in some embodiments, a control unit 108 may receive one or more signals 106. In some embodiments, a control unit 108 may include one or more control transmitters 200. Accordingly, in some embodiments, a control unit 108 may transmit one or more signals 106. In some embodiments, a control unit 108 may include one or more control processors 192. Accordingly, in some embodiments, a control unit 108 may process one or more signals 106. In some embodiments, a control unit 108 may include control memory 196. In some embodiments, a control unit 108 may include control logic 194. In some embodiments, a control unit 108 may include one or more control databases 202.

In some embodiments, a control unit 108 may be configured to control the operation of one or more dissection units 102. For example, in some embodiments, a control unit 108 may be configured to control the operation of one or more pumps 116. In some embodiments, a control unit 108 may be configured to control the operation of one or more motors 120.

In some embodiments, a control unit 108 may be configured to control the operation of one or more imaging apparatuses 104. For example, in some embodiments, a control unit 108 may be configured to control the frequency with which one or more imaging apparatuses 104 acquire one or more images. In some embodiments, a control unit 108 may be configured to control the sensitivity with which one or more imaging apparatuses 104 acquire one or more images. Accordingly, in some embodiments, a control unit 108 may be configured to control the operation of one or more microscopes 154. For example, in some embodiments, a control unit 108 may control the magnification used by the microscope 154. In some embodiments, a control unit 108 may control the mode used by the microscope 154 (e.g., dark field). In some embodiments, a control unit 108 may be configured to control the operation of one or more cameras 156. For example, in some embodiments, a control unit 108 may control the shutter speed of the camera 156. In some embodiments, a control unit 108 may control the field of view of the camera 156.

In some embodiments, a control unit 108 may receive one or more signals 106 that are transmitted from one or more dissection units 102. For example, in some embodiments, a control unit 108 may receive one or more signals 106 that indicate the operating status of one or more pumps 116. In some embodiments, a control unit 108 may receive one or more signals 106 that indicate the operating status of one or more motors 120.

In some embodiments, a control unit 108 may receive one or more signals 106 that are transmitted from one or more imaging apparatuses 104. For example, in some embodiments, a control unit 108 may receive one or more signals 106 that indicate the operating status of one or more microscopes 154. For example, in some embodiments, a control unit 108 may receive one or more signals 106 that indicate the level of magnification being used by a microscope 154. In some embodiments, a control unit 108 may receive one or more signals 106 that indicate the operating status of one or more cameras 156. For example, in some embodiments, a control unit 108 may receive one or more signals 106 that indicate the sensitivity level under which a camera 156 is operating. In some embodiments, a control unit 108 may receive one or more signals 106 that indicate the field of view under which a camera 156 is operating. In some embodiments, a control unit 108 may receive one or more signals 106 that include one or more images that are acquired by one or more imaging apparatuses 104.

In some embodiments, a control unit 108 may receive one or more signals 106 that are transmitted from one or more user interfaces 110. In some embodiments, a control unit 108 may receive one or more signals 106 that include one or more instructions associated with controlling the operation of one or more dissection units 102. For example, in some embodiments, a control unit 108 may receive one or more signals 106 that include one or more instructions associated with controlling the operation of one or more pumps 116. In some embodiments, a control unit 108 may receive one or more signals 106 that include one or more instructions associated with controlling the operation of one or more motors 120. In some embodiments, a control unit 108 may receive one or more signals 106 that include one or more instructions associated with controlling the operation of one or more imaging apparatuses 104. For example, in some embodiments, a control unit 108 may receive one or more signals 106 that include one or more instructions associated with controlling the operation of one or more cameras 156.

In some embodiments, a control unit 108 may transmit one or more signals 106 that are received by one or more dissection units 102. For example, in some embodiments, a control unit 108 may transmit one or more signals 106 that are associated with controlling the operation of one or more motors 120. In some embodiments, a control unit 108 may transmit one or more signals 106 that are associated with controlling the operation of one or more pumps 116. In some embodiments, a control unit 108 may receive one or more signals 106 that were transmitted by one or more imaging apparatuses 104 that include one or more acquired images of one or more insects in one or more dissection units 102. The control unit 108 may then process the one or more images and determine the extent to which the insects in the dissection unit 102 have been dissected (e.g. using image recognition techniques or algorithms). The control unit 108 may then transmit one or more signals 106 that are received by one or more dissection units 102 that control the operation of one or more motors 120. For example, the one or more signals 106 may instruct the motor to increase, decrease, or maintain a level of operation.

In some embodiments, a control unit 108 may transmit one or more signals 106 that are received by one or more imaging apparatuses 104. In some embodiments, a control unit 108 may transmit one or more signals 106 that are associated with controlling the operation of one or more imaging apparatuses 104. In some embodiments, a control unit 108 may transmit one or more signals 106 that are associated with controlling the operation of one or more microscopes 154. In some embodiments, a control unit 108 may transmit one or more signals 106 that are associated with controlling the operation of one or more cameras 156.

In some embodiments, a control unit 108 may transmit one or more signals 106 that are received by one or more user interfaces 110. In some embodiments, a control unit 108 may transmit one or more signals 106 that are associated with one or more images that were acquired by one or more imaging apparatuses 104. In some embodiments, a control unit 108 may transmit one or more signals 106 that are associated with information related to operation of one or more dissection units 102. For example, in some embodiments, a control unit 108 may transmit one or more signals 106 that include information related to the operational level of one or more pumps 116. In some embodiments, a control unit 108 may transmit one or more signals 106 that include information related to the operational level of one or more motors 120.

### User Interface

In some embodiments, system 100 may include one or more user interfaces 110. A user interface 110 may be configured in numerous ways. In some embodiments, a user interface 110 may include one or more mobile device interfaces 204. For example, in some embodiments, a user interface 110 may be configured to receive one or more signals 106 and transmit one or more signals 106 to a cellular telephone or other such mobile device. In some embodiments, a user interface 110 may include one or more user transmitters 212. In some embodiments, a user interface 110 may include one or more user receivers 214. In some embodiments, a user interface 110 may include one or more interface processors 218. In some embodiments, a user interface 110 may include interface memory 216. Accordingly, in some embodiments, a user interface 110 may receive, transmit, and process one or more signals 106. In some embodiments, a user interface 110 may include one or more keyboards 206. In some embodiments, a user interface 110 may include one or more touchpads 208. In some embodiments, a user interface 110 may include one or more user displays 210. In some embodiments, a user interface 110 may include one or more active user displays 210. In some embodiments, a user interface 110 may include one or more passive user displays 210.

In some embodiments, a user interface 110 may be configured to transmit and receive one or more signals 106. For example, in some embodiments, a user interface 110 may receive one or more signals 106 that were transmitted by an imaging apparatus 104 that include one or more images of an insect that is being dissected in a dissection unit 102. The one or more images may then be displayed on the user interface 110 such that a user 116 may view the one or more images. A user 116 may then determine the extent to which the one or more insects are dissected and cause the user interface 110 to transmit one or more signals 106 that instruct one or more dissection units to increase, decrease, or maintain the level of operation of one or more motors 120 and/or pumps 116.

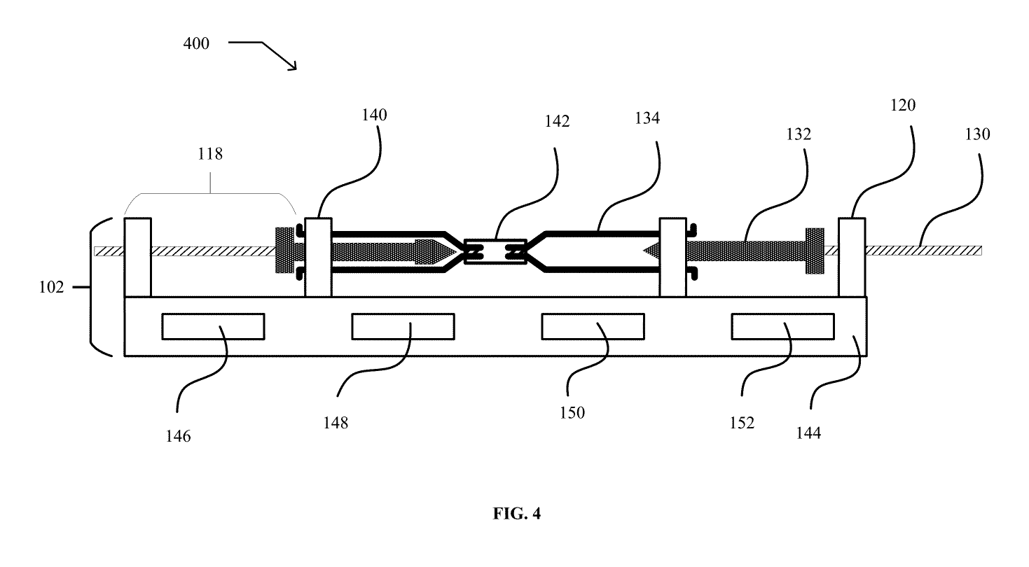

FIG. 4 illustrates a side, partial cross-sectional view of an example system 400. System 400 is shown with an embodiment of a dissection unit 102 having two fluid reservoirs 134 that are configured as syringe barrels and that are operably coupled through a hydrodynamic shear member 142. The two fluid reservoirs 134 are operably coupled to a base member 144 through two reservoir supports 140. Included within each of the fluid reservoirs 134 is a fluid displacement member 132 that is configured as a plunger and moveably coupled within the fluid reservoir 134. Each of the fluid displacement members 132 is operably coupled to a drive mechanism 118 that includes a threaded actuator 130 that is operably coupled to a motor 120. Accordingly, the motors 120 may operate in a coordinated manner to move the two fluid displacement members 132 in opposite directions to each other within each of the two or more fluid reservoirs 134. For example, in some embodiments, a first drive mechanism 118 may move a first fluid displacement member 132 into a first fluid reservoir 134 and a second drive mechanism 118 may move a second fluid displacement member 132 out of a second fluid reservoir 134 with the first and second drive mechanisms 118 working in coordination with each other. Accordingly, in some embodiments, fluid may be pushed back and forth between the two reservoirs 134 through a hydrodynamic shear member 142. System 400 may include one or more fluid receivers 146. Accordingly, in some embodiments, system 400 may receive one or more signals 106. For example, in some embodiments, system 400 may receive one or more signals 106 that were transmitted by one or more control units 108. In some embodiments, system 400 may receive one or more signals 106 that were transmitted by one or more user interfaces 110. System 400 may include one or more fluid transmitters 148. Accordingly, in some embodiments, system 400 may transmit one or more signals 106. For example, in some embodiments, system 400 may transmit one or more signals 106 that are received by one or more control units 108. In some embodiments, system 400 may transmit one or more signals 106 that are received by one or more user interfaces 110. System 400 may include one or more fluid processors 150. Accordingly, in some embodiments, system 400 may process one or more signals 106. System 400 may include fluid memory 152. Accordingly, in some embodiments, system 400 may store information.

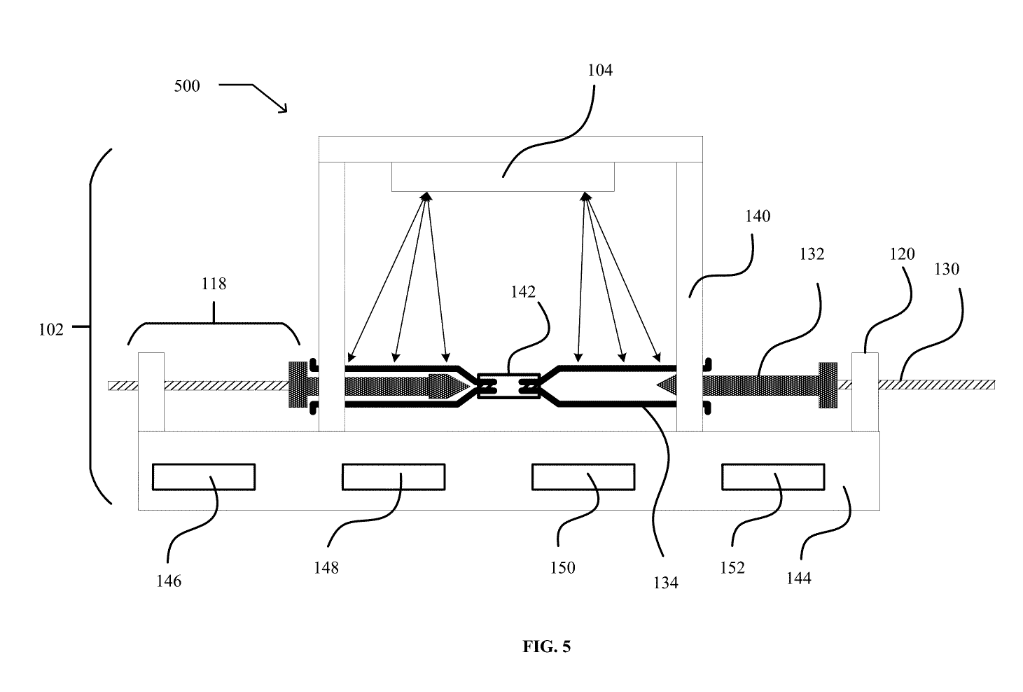

FIG. 5 illustrates a side, partial cross-sectional view of an example system 500. System 500 is shown with an embodiment of a dissection unit 102 having two fluid reservoirs 134 that are configured as syringe barrels and that are operably coupled through a hydrodynamic shear member 142. The two fluid reservoirs 134 are operably coupled to a base member 144 through two reservoir supports 140. Included within each of the fluid reservoirs 134 is a fluid displacement member 132 that is configured as a plunger and moveably coupled within the fluid reservoir 134. Each of the fluid displacement members 132 is operably coupled to a drive mechanism 118 that includes a threaded actuator 130 that is operably coupled to a motor 120. Accordingly, the motors 120 may operate in a coordinated manner to move the two fluid displacement members 132 in opposite directions to each other within each of the two or more fluid reservoirs 134. For example, in some embodiments, a first drive mechanism 118 may move a first fluid displacement member 132 into a first fluid reservoir 134 and a second drive mechanism 118 may move a second fluid displacement member 132 out of a second fluid reservoir 134 with the first and second drive mechanisms 118 working in coordination with each other. Accordingly, in some embodiments, fluid may be pushed back and forth between the two reservoirs 134 through a hydrodynamic shear member 142. System 500 may include one or more fluid receivers 146. Accordingly, in some embodiments, system 500 may receive one or more signals 106. For example, in some embodiments, system 500 may receive one or more signals 106 that were transmitted by one or more control units 108. In some embodiments, system 500 may receive one or more signals 106 that were transmitted by one or more user interfaces 110. System 500 may include one or more fluid transmitters 148. Accordingly, in some embodiments, system 500 may transmit one or more signals 106. For example, in some embodiments, system 500 may transmit one or more signals 106 that are received by one or more control units 108. In some embodiments, system 500 may transmit one or more signals 106 that are received by one or more user interfaces 110. System 500 may include one or more fluid processors 150. Accordingly, in some embodiments, system 500 may process one or more signals 106. System 500 may include fluid memory 152. Accordingly, in some embodiments, system 500 may store information. In some embodiments, system 500 may include one or more imaging apparatuses 104. In some embodiments, one or more imaging apparatuses 104 may be configured to acquire one or more images of one or more insects that are contained within one or more fluid reservoirs 134.

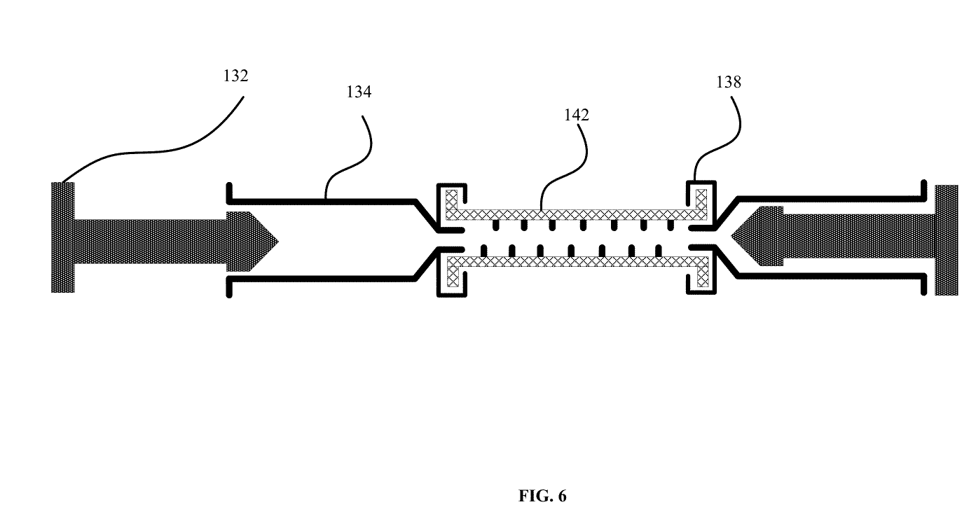

FIG. 6 illustrates a hydrodynamic shear member 142 that is configured as a hydrodynamic cavitation device (e.g., McGuire et al., Hydrodynamic cavitation device, Published U.S. Patent Application: 20130088935, herein incorporated by reference). The hydrodynamic shear member 142 is operably coupled to two fluid reservoirs 134 through two luer lock couplings 138. A fluid displacement member 132 is operably coupled to each of fluid reservoirs 134.

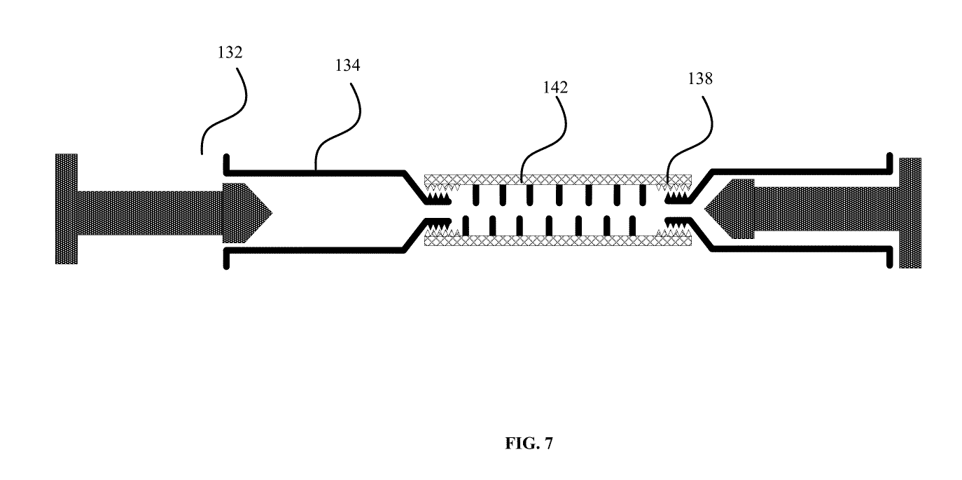

FIG. 7 illustrates a hydrodynamic shear member 142 that is configured as a hydrodynamic cavitation device (e.g., McGuire et al., Hydrodynamic cavitation device, Published U.S. Patent Application: 20130088935, herein incorporated by reference). The hydrodynamic shear member 142 is operably coupled to two fluid reservoirs 134 through two threaded couplings 138. A fluid displacement member 132 is operably coupled to each of fluid reservoirs 134.

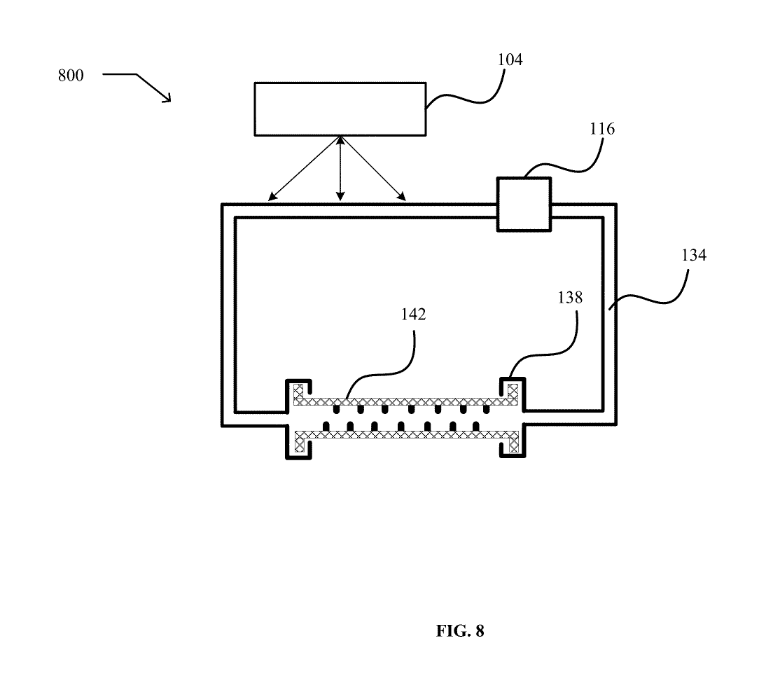

FIG. 8 illustrates system 800 that includes a hydrodynamic shear member 142 that is configured as a hydrodynamic cavitation device (e.g., McGuire et al., Hydrodynamic cavitation device, Published U.S. Patent Application: 20130088935, herein incorporated by reference) and operably coupled with a fluid reservoir 134. The hydrodynamic shear member 142 is operably coupled to the fluid reservoir 134 through two luer lock couplings 138. The fluid reservoir 134 is operably coupled to a pump 116. In some embodiments, system 800 may include one or more imaging apparatuses 104. In some embodiments, one or more imaging apparatuses 104 may be configured to acquire one or more images of one or more insects that are contained within one or more fluid reservoirs 134.

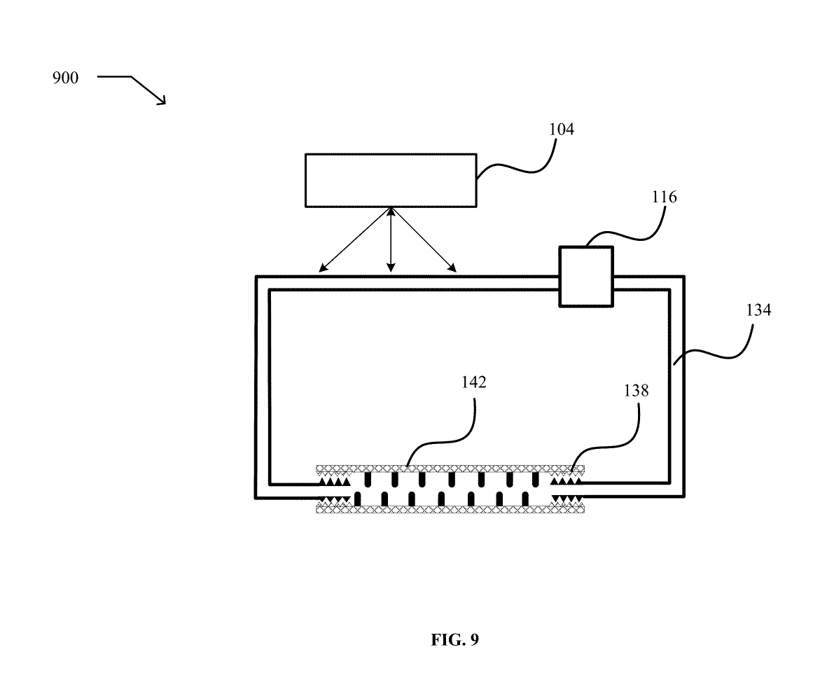

FIG. 9 illustrates system 900 that includes a hydrodynamic shear member 142 that is configured as a hydrodynamic cavitation device (e.g., McGuire et al., Hydrodynamic cavitation device, Published U.S. Patent Application: 20130088935, herein incorporated by reference) and operably coupled with a fluid reservoir 134. The hydrodynamic shear member 142 is operably coupled to the fluid reservoir 134 through two threaded couplings 138. The fluid reservoir 134 is operably coupled with a pump 116. In some embodiments, system 800 may include one or more imaging apparatuses 104. In some embodiments, one or more imaging apparatuses 104 may be configured to acquire one or more images of one or more insects that are contained within one or more fluid reservoirs 134.

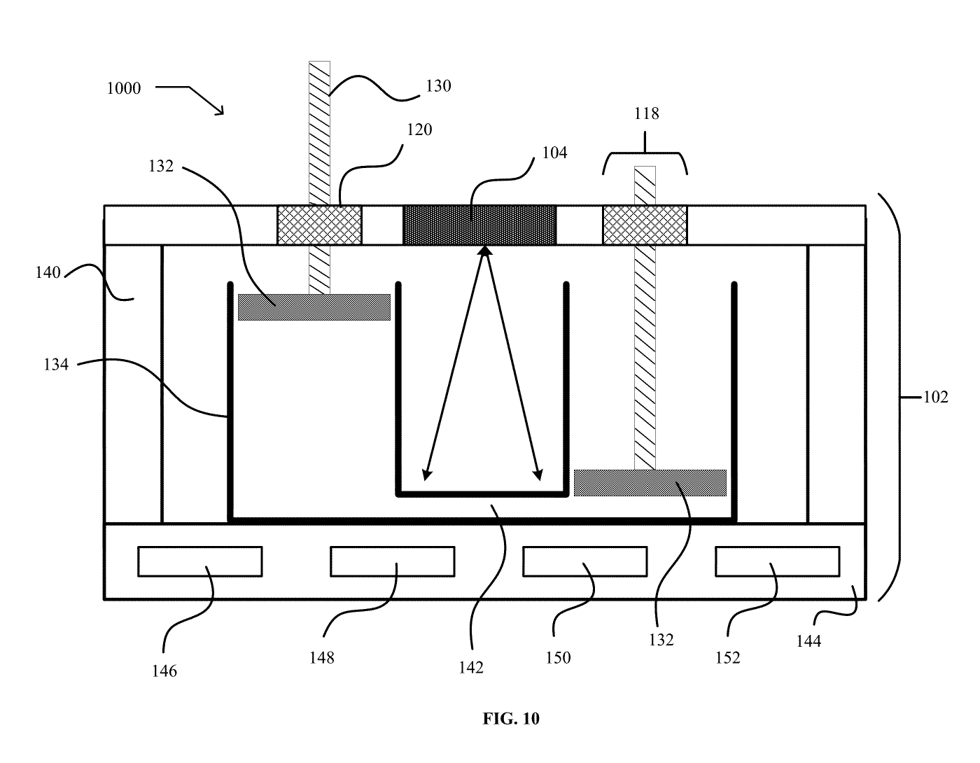

FIG. 10 illustrates a side, partial cross-sectional view of an example system 1000. System 1000 is shown with an embodiment of a dissection unit 102 having two fluid reservoirs 134 that are operably coupled through a hydrodynamic shear member 142. The two fluid reservoirs 134 are operably coupled to a base member 144. Included within each of the fluid reservoirs 134 is a fluid displacement member 132 that is moveably coupled within the fluid reservoir 134. Each of the fluid displacement members 132 is operably coupled to a drive mechanism 118 that includes a threaded actuator 130 that is operably coupled to a motor 120. Accordingly, the motors 120 may operate in a coordinated manner to move the two fluid displacement members 132 in opposite directions to each other within each of the two or more fluid reservoirs 134. For example, in some embodiments, a first drive mechanism 118 may move a first fluid displacement member 132 into a first fluid reservoir 134 and a second drive mechanism 118 may move a second fluid displacement member 132 out of a second fluid reservoir 134 with the first and second drive mechanisms 118 working in coordination with each other. Accordingly, in some embodiments, fluid may be pushed back and forth between the two reservoirs 134 through a hydrodynamic shear member 142. System 1000 may include one or more fluid receivers 146. Accordingly, in some embodiments, system 1000 may receive one or more signals 106. For example, in some embodiments, system 1000 may receive one or more signals 106 that were transmitted from one or more control units 108. In some embodiments, system 1000 may receive one or more signals 106 that were transmitted from one or more user interfaces 110. System 1000 may include one or more fluid transmitters 148. Accordingly, in some embodiments, system 1000 may transmit one or more signals 106. For example, in some embodiments, system 1000 may transmit one or more signals 106 that are received by one or more control units 108. In some embodiments, system 1000 may transmit one or more signals 106 that are received by one or more user interfaces 110. System 1000 may include one or more fluid processors 150. Accordingly, in some embodiments, system 1000 may process one or more signals 106. System 1000 may include fluid memory 152. Accordingly, in some embodiments, system 1000 may store information. In some embodiments, system 1000 may include one or more imaging apparatuses 104. In some embodiments, one or more imaging apparatuses 104 may be configured to acquire one or more images of one or more insects that are contained within one or more fluid reservoirs 134.

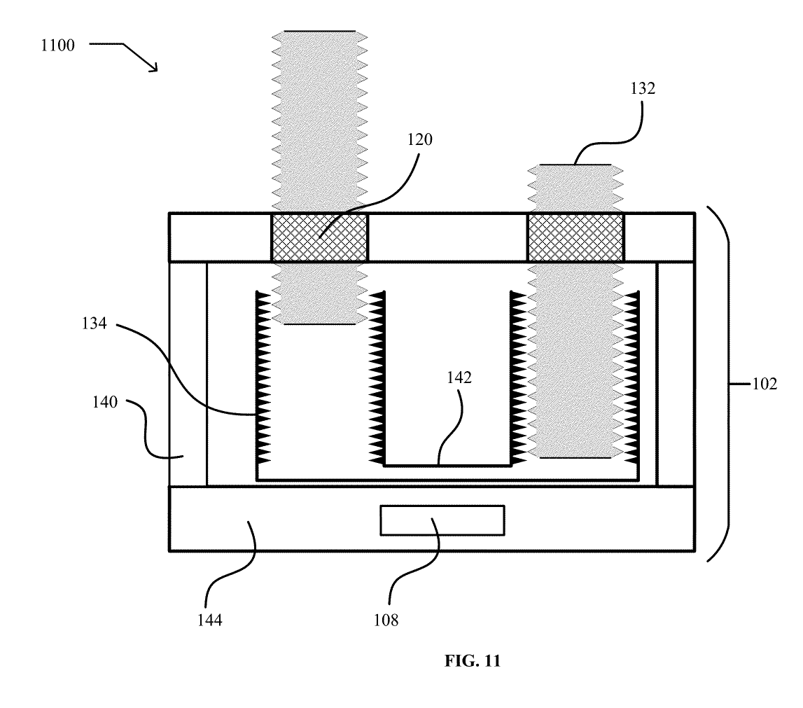

FIG. 11 illustrates a side, partial cross-sectional view of an example system 1100. System 1100 is shown with an embodiment of a dissection unit 102 having two threaded fluid reservoirs 134 that are operably coupled through a hydrodynamic shear member 142. The two threaded fluid reservoirs 134 are operably coupled to a base member 144. Included within each of the threaded fluid reservoirs 134 is a threaded fluid displacement member 132 that is moveably coupled within the threaded fluid reservoir 134. Each of the threaded fluid displacement members 132 is operably coupled to a motor 120. Accordingly, the motors 120 may operate in a coordinated manner to move the two threaded fluid displacement members 132 in opposite directions to each other within each of the threaded fluid reservoirs 134. Accordingly, in some embodiments, fluid may be pushed back and forth between the two reservoirs 134 through a hydrodynamic shear member 142. System 1100 may include a control unit 108 that can be configured to control operation of the two motors 120.

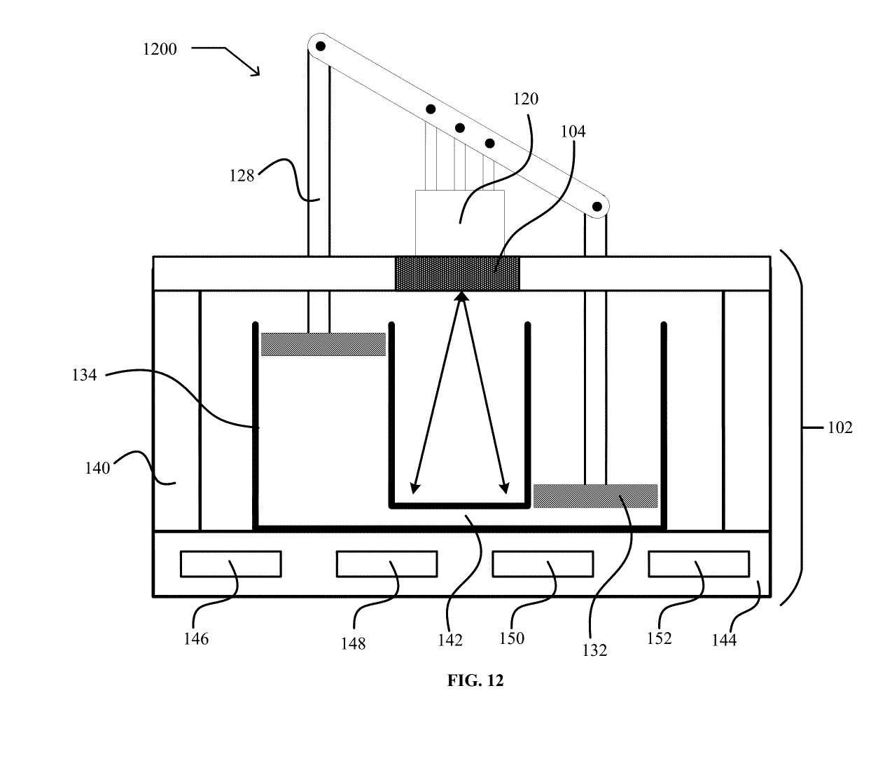

FIG. 12 illustrates a side, partial cross-sectional view of an example system 1200. System 1200 is shown with an embodiment of a dissection unit 102 having two fluid reservoirs 134 that are operably coupled through a hydrodynamic shear member 142. The two fluid reservoirs 134 are operably coupled to a base member 144. Included within each of the fluid reservoirs 134 is a fluid displacement member 132 that is moveably coupled within the fluid reservoir 134. Each of the fluid displacement members 132 is operably coupled to an actuator 128 that is operably coupled to a motor 120. Accordingly, the motor 120 may operate to move the two fluid displacement members 132 in opposite directions to each other within each of the two fluid reservoirs 134. Accordingly, in some embodiments, fluid may be pushed back and forth between the two reservoirs 134 through a hydrodynamic shear member 142. System 1200 may include one or more fluid receivers 146. Accordingly, in some embodiments, system 1200 may receive one or more signals 106. For example, in some embodiments, system 1200 may receive one or more signals 106 that were transmitted from one or more control units 108. In some embodiments, system 1200 may receive one or more signals 106 that were transmitted from one or more user interfaces 110. System 1200 may include one or more fluid transmitters 148. Accordingly, in some embodiments, system 1200 may transmit one or more signals 106. For example, in some embodiments, system 1200 may transmit one or more signals 106 that are received by one or more control units 108. In some embodiments, system 1200 may transmit one or more signals 106 that are received by one or more user interfaces 110. System 1200 may include one or more fluid processors 150. Accordingly, in some embodiments, system 1200 may process one or more signals 106. System 1200 may include fluid memory 152. Accordingly, in some embodiments, system 1200 may store information. In some embodiments, system 1200 may include one or more imaging apparatuses 104. In some embodiments, one or more imaging apparatuses 104 may be configured to acquire one or more images of one or more insects that are contained within one or more fluid reservoirs 134.

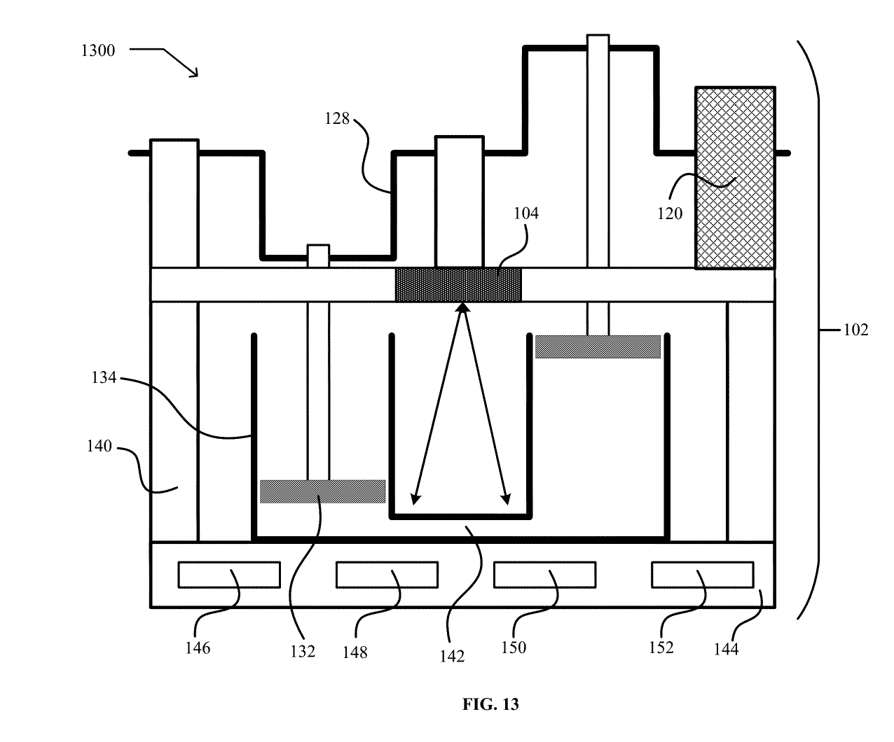

FIG. 13 illustrates a side, partial cross-sectional view of an example system 1300. System 1300 is shown with an embodiment of a dissection unit 102 having two fluid reservoirs 134 that are operably coupled through a hydrodynamic shear member 142. The two fluid reservoirs 134 are operably coupled to a base member 144. Included within each of the fluid reservoirs 134 is a fluid displacement member 132 that is moveably coupled within the fluid reservoir 134. Each of the fluid displacement members 132 is operably coupled to a crankshaft-type actuator 128 that is operably coupled to a motor 120. Accordingly, the motor 120 may operate to move the two fluid displacement members 132 in opposite directions to each other within each of the two fluid reservoirs 134. Accordingly, in some embodiments, fluid may be pushed back and forth between the two reservoirs 134 through a hydrodynamic shear member 142. System 1300 may include one or more fluid receivers 146. Accordingly, in some embodiments, system 1300 may receive one or more signals 106. For example, in some embodiments, system 1300 may receive one or more signals 106 that were transmitted from one or more control units 108. In some embodiments, system 1200 may receive one or more signals 106 that were transmitted from one or more user interfaces 110. System 1300 may include one or more fluid transmitters 148. Accordingly, in some embodiments, system 1300 may transmit one or more signals 106. For example, in some embodiments, system 1300 may transmit one or more signals 106 that are received by one or more control units 108. In some embodiments, system 1300 may transmit one or more signals 106 that are received by one or more user interfaces 110. System 1300 may include one or more fluid processors 150. Accordingly, in some embodiments, system 1300 may process one or more signals 106. System 1300 may include fluid memory 152. Accordingly, in some embodiments, system 1300 may store information. In some embodiments, system 1300 may include one or more imaging apparatuses 104. In some embodiments, one or more imaging apparatuses 104 may be configured to acquire one or more images of one or more insects that are contained within one or more fluid reservoirs 134.

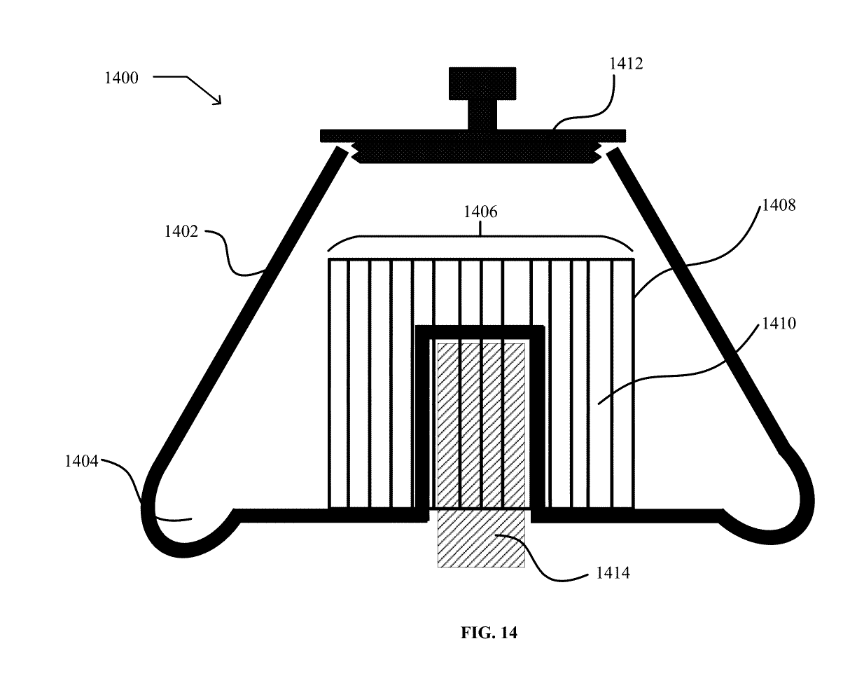

FIG. 14 illustrates a side, partial cross-sectional view of a centrifuge rotor 1400. The centrifuge rotor 1400 includes a triangular rotor body 1402. The triangular rotor body 1402 is configured to have a trough 1404 that is positioned at the bottom of the triangular rotor body 1402. A separation member 1406 is operably coupled to the triangular rotor body 1402. The separation member 1406 includes vertical vanes 1408 and spaces 1410 between the vertical vanes 1408 in the separation member 1406. Accordingly, in some embodiments, a sample may be placed within the separation member 1406. The sample may then be centrifuged and components of the sample that are too large to pass through the spaces 1410 in the separation member 1406 are retained on the inside of the separation member 1406. Components of the sample that are small enough to pass through the spaces 1410 in the separation member 1406 may be collected in the trough 1404 of the triangular rotor body 1402. A rotor lid 1408 may be operably coupled to the triangular rotor body 1402. The triangular rotor body 1402 is configured to operably associate with a centrifuge drive spindle 1414. In some embodiments, centrifuge rotor 1400 may be used to collect insect salivary glands. For example, in some embodiments, headless thoraxes of one or more insects may be placed within a separation member 1406 having spaces 1410 that disallow passage of the insect thoraxes through the separation member 1406 but that allow passage of insect salivary glands through the spaces 1410 to be collected in the trough 1404 of the triangular rotor body 1402. In some embodiments, headless thoraxes of one or more mosquitos may be placed within a separation member 1406 having spaces 1410 that disallow passage of the mosquito thoraxes through the separation member 1406 but that allow passage of mosquito salivary glands through the spaces 1410 to be collected in the trough 1404 of the triangular rotor body 1402. In some embodiments, centrifuge rotor 1400 may be used to collect sporozoites. For example, in some embodiments, a sample that includes mosquito salivary glands containing sporozoites may be placed within a separation member 1406 having spaces 1410 that allow passage of sporozoites but that disallow larger components of the sample. Accordingly, in some embodiments, sporozoites may be collected in the trough 1404 of the triangular rotor body 1402.

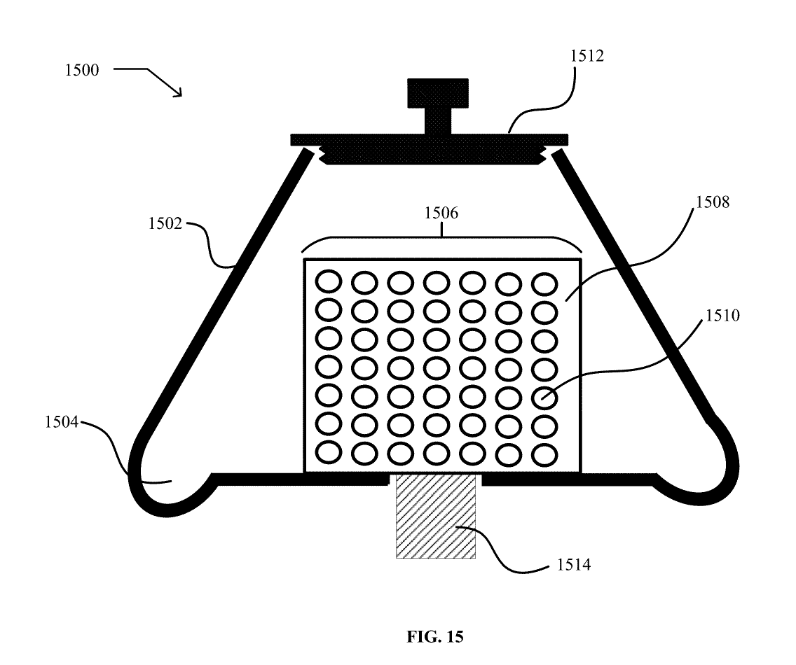

FIG. 15 illustrates a side, partial cross-sectional view of a centrifuge rotor 1500. The centrifuge rotor 1500 includes a triangular rotor body 1502. The triangular rotor body 1502 is configured to have a trough 1504 that is positioned at the bottom of the triangular rotor body 1502. A separation member 1506 is operably coupled to the triangular rotor body 1502. The separation member 1506 may include a solid portion 1508 that includes a plurality of pores 1510. Accordingly, in some embodiments, a sample may be placed within the separation member 1506. The sample may then be centrifuged and components of the sample that are too large to pass through the pores 1510 in the separation member 1506 are retained on the inside of the separation member 1506. Components of the sample that are small enough to pass through the pores 1510 in the separation member 1506 are collected in the trough 1504 of the triangular rotor body 1502. A rotor lid 1508 may be operably coupled to the triangular rotor body 1502. The triangular rotor body 1502 is configured to operably associate with a centrifuge drive spindle 1514. In some embodiments, centrifuge rotor 1500 may be used to collect insect salivary glands. For example, in some embodiments, headless thoraxes of one or more insects may be placed within a separation member 1506 having pores 1510 that disallow passage of the insect thoraxes through the separation member 1506 but that allow passage of insect salivary glands through the pores 1510 to be collected in the trough 1504 of the triangular rotor body 1502. In some embodiments, headless thoraxes of one or more mosquitos may be placed within a separation member 1506 having pores 1510 that disallow passage of the mosquito thoraxes through the separation member 1506 but that allow passage of mosquito salivary glands through the pores 1510 to be collected in the trough 1504 of the triangular rotor body 1502. In some embodiments, centrifuge rotor 1500 may be used to collect sporozoites. For example, in some embodiments, a sample that includes mosquito salivary glands containing sporozoites may be placed within a separation member 1506 having pores 1510 that allow passage of sporozoites but that disallow larger components of the sample. Accordingly, in some embodiments, sporozoites may be collected in the trough 1504 of the triangular rotor body 1502.

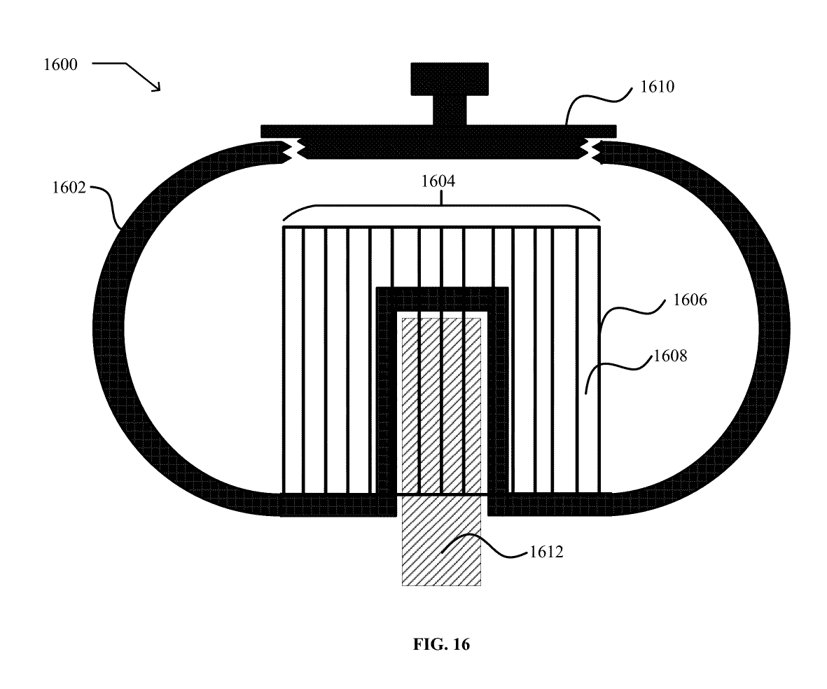

FIG. 16 illustrates a side, partial cross-sectional view of a centrifuge rotor 1600. The centrifuge rotor 1600 includes an ovoid rotor body 1602. A separation member 1604 is operably coupled to the ovoid rotor body 1602. The separation member 1604 includes vertical vanes 1606 and spaces 1608 between the vertical vanes 1606 in the separation member 1604. Accordingly, in some embodiments, a sample may be placed within the separation member 1604. The sample may then be centrifuged and components of the sample that are too large to pass through the spaces 1608 in the separation member 1604 are retained on the inside of the separation member 1604. Components of the sample that are small enough to pass through the spaces 1608 in the separation member 1604 may be collected in the ovoid rotor body 1602 on the outside of the separation member 1604. A rotor lid 1610 may be operably coupled to the ovoid rotor body 1602. The ovoid rotor body 1602 is configured to operably associate with a centrifuge drive spindle 1612. In some embodiments, centrifuge rotor 1600 may be used to collect insect salivary glands. For example, in some embodiments, headless thoraxes of one or more insects may be placed within a separation member 1604 having spaces 1608 that disallow passage of the insect thoraxes through the separation member 1604 but that allow passage of insect salivary glands through the spaces 1608 to be collected in the ovoid rotor body 1602 on the outside of the separation member 1604. In some embodiments, headless thoraxes of one or more mosquitos may be placed within a separation member 1604 having spaces 1608 that disallow passage of the mosquito thoraxes through the separation member 1604 but that allow passage of mosquito salivary glands through the spaces 1608 to be collected in the ovoid rotor body 1602 on the outside of the separation member 1604. In some embodiments, centrifuge rotor 1600 may be used to collect sporozoites. For example, in some embodiments, a sample that includes mosquito salivary glands containing sporozoites may be placed within a separation member 1604 having spaces 1608 that allow passage of sporozoites but that disallow larger components of the sample. Accordingly, in some embodiments, sporozoites may be collected in the ovoid rotor body 1602 on the outside of the separation member 1604.

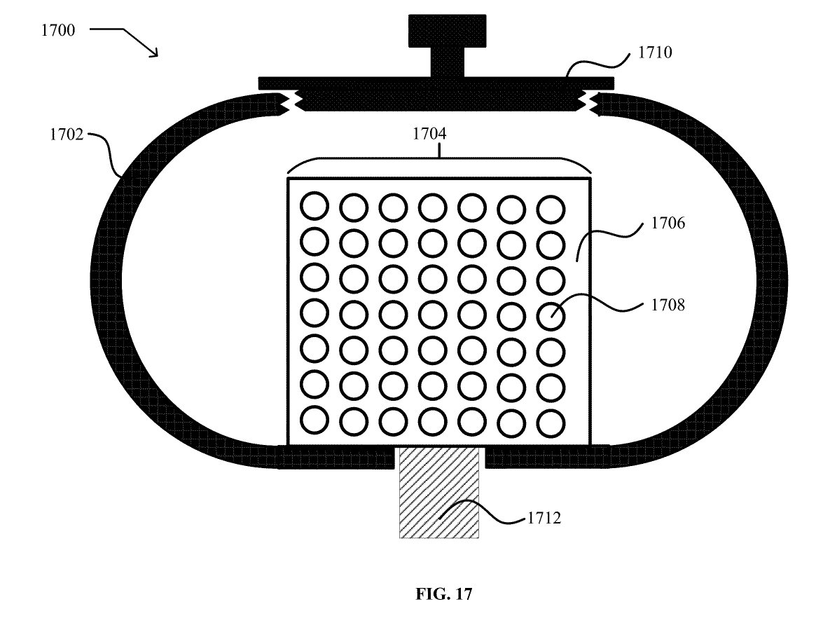

FIG. 17 illustrates a side, partial cross-sectional view of a centrifuge rotor 1700. The centrifuge rotor 1700 includes an ovoid rotor body 1702. A separation member 1704 is operably coupled to the ovoid rotor body 1702. The separation member 1704 may include a solid portion 1706 that includes a plurality of pores 1708. Accordingly, in some embodiments, a sample may be placed within the separation member 1704. The sample may then be centrifuged and components of the sample that are too large to pass through the pores 1708 in the separation member 1708 are retained on the inside of the separation member 1704. Components of the sample that are small enough to pass through the pores 1708 in the separation member 1704 are collected in the ovoid rotor body 1702 on the outside of the separation member 1704. A rotor lid 1710 may be operably coupled to the ovoid rotor body 1702. The ovoid rotor body 1702 is configured to operably associate with a centrifuge drive spindle 1712. In some embodiments, centrifuge rotor 1700 may be used to collect insect salivary glands. For example, in some embodiments, headless thoraxes of one or more insects may be placed within a separation member 1704 having pores 1708 that disallow passage of the insect thoraxes through the separation member 1704 but that allow passage of insect salivary glands through the pores 1708 to be collected in the ovoid rotor body 1702 on the outside of the separation member 1704. In some embodiments, headless thoraxes of one or more mosquitos may be placed within a separation member 1704 having pores 1708 that disallow passage of the mosquito thoraxes through the separation member 1704 but that allow passage of mosquito salivary glands through the pores 1708 to be collected in the ovoid rotor body 1702 on the outside of the separation member 1704. In some embodiments, centrifuge rotor 1700 may be used to collect sporozoites. For example, in some embodiments, a sample that includes mosquito salivary glands containing sporozoites may be placed within a separation member 1704 having pores 1708 that allow passage of sporozoites but that disallow larger components of the sample. Accordingly, in some embodiments, sporozoites may be collected in the ovoid rotor body 1702 on the outside of the separation member 1704.

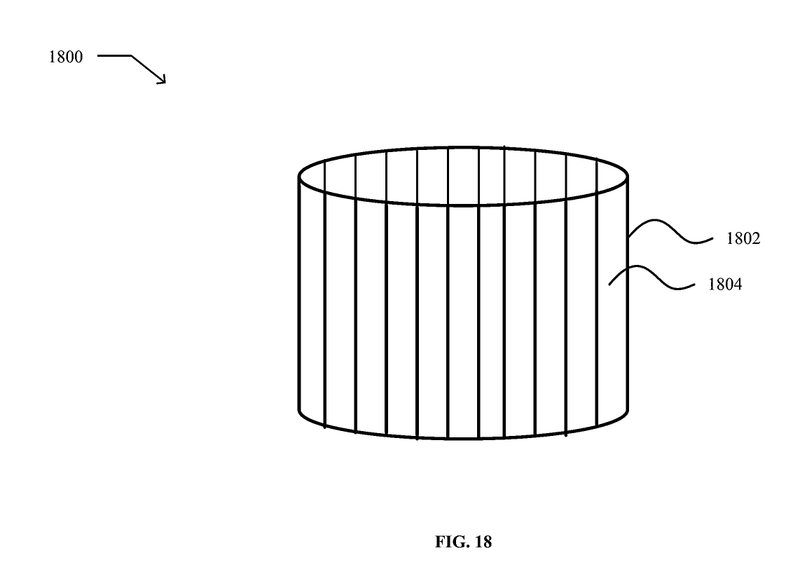

FIG. 18 illustrates a side view of a separation member 1800 having vertical vanes 1802 and spaces 1804 between the vertical vanes 1802. In some embodiments, a separation member 1800 may be configured to provide for separation of bodily parts from an insect. In some embodiments, the spaces 1804 between the vertical vanes 1802 may be configured for use with a mosquito. For example, in some embodiments, the spaces 1804 may be sized and shaped to disallow passage of mosquito thoraxes through the separation member 1800 but permit passage of mosquito salivary glands through the separation member 1800 during rotation of the separation member 1800.

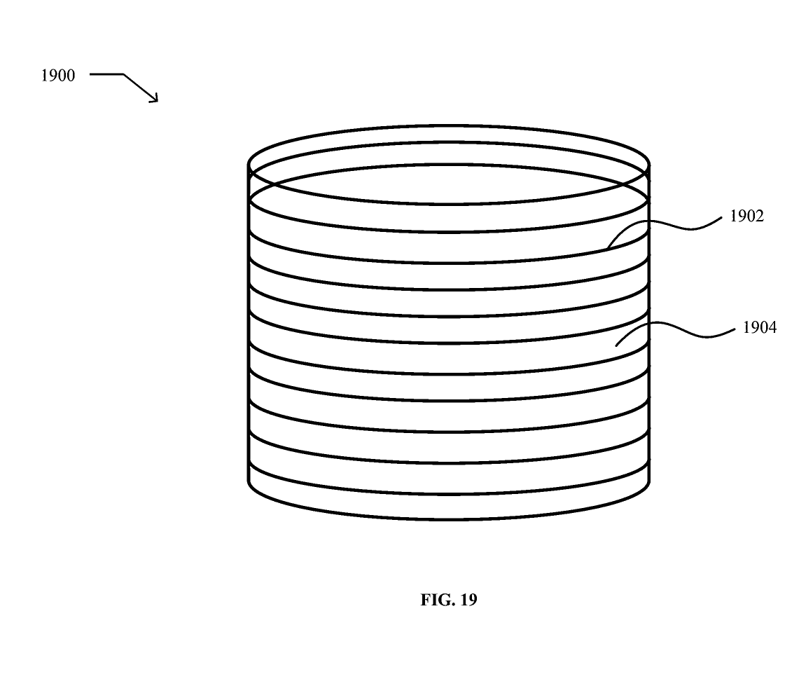

FIG. 19 illustrates a side view of a separation member 1900 having horizontal vanes 1902 and spaces 1904 between the horizontal vanes 1902. In some embodiments, a separation member 1900 may be configured to provide for separation of bodily parts from an insect. In some embodiments, the spaces 1904 between the horizontal vanes 1902 may be configured for use with a mosquito. For example, in some embodiments, the spaces 1904 may be sized and shaped to disallow passage of mosquito thoraxes through the separation member 1900 but permit passage of mosquito salivary glands through the separation member 1900 during rotation of the separation member 1900.

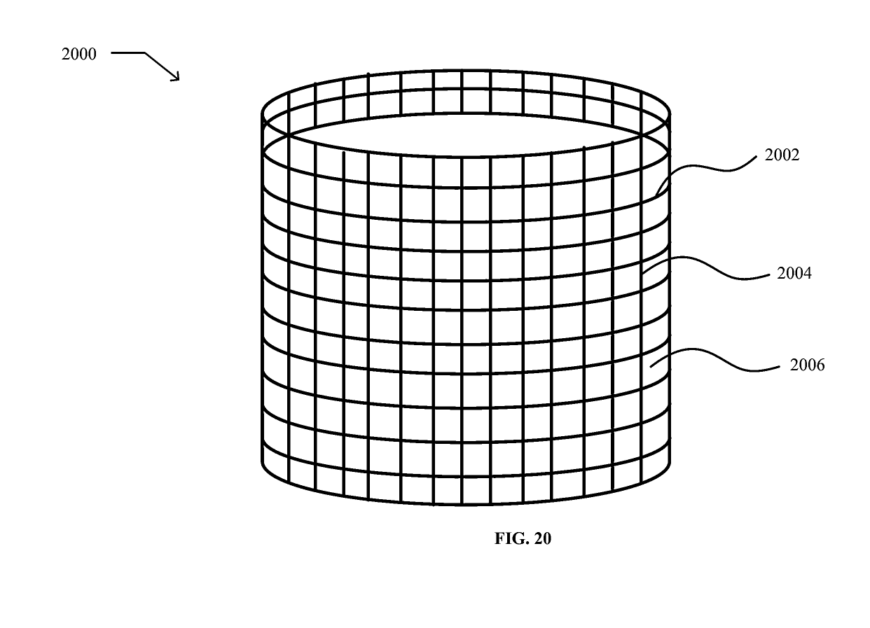

FIG. 20 illustrates a side view of a separation member 2000 that includes horizontal 2002 and vertical vanes 2004 and spaces 2006 between the horizontal 2002 and vertical vanes 2004. In some embodiments, a separation member 2000 may be configured to provide for separation of bodily parts from an insect. In some embodiments, the spaces 2006 between the horizontal vanes 2002 and the vertical vanes 2004 may be configured for use with a mosquito. For example, in some embodiments, the spaces 2006 may be sized and shaped to disallow passage of mosquito thoraxes through the separation member 2000 but permit passage of mosquito salivary glands through the separation member 2000 during rotation of the separation member 2000.

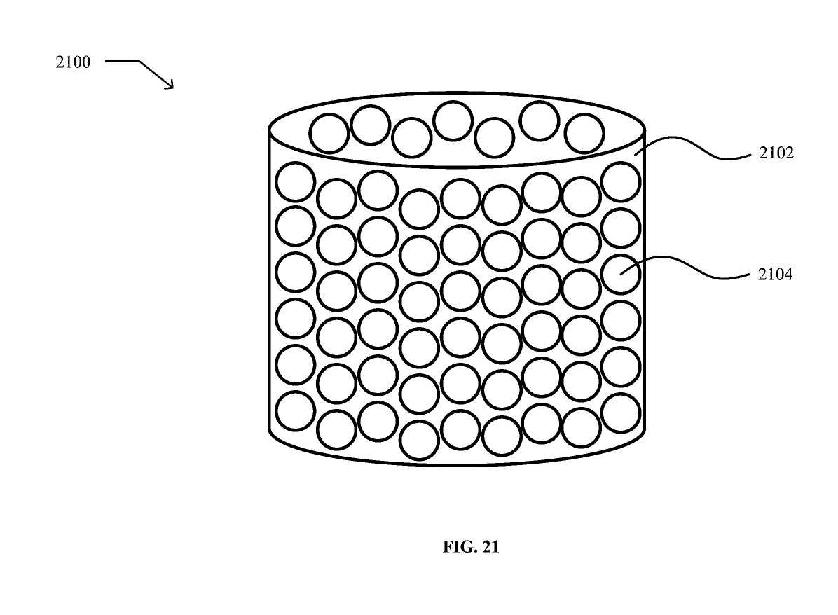

FIG. 21 illustrates a side view of a separation member 2100 that includes a solid portion 2102 that includes a plurality of pores 2104. In some embodiments, a separation member 2100 may be configured to provide for separation of bodily parts from an insect. In some embodiments, the pores 2104 may be configured for use with a mosquito. For example, in some embodiments, the pores 2104 may be sized and shaped to disallow passage of mosquito thoraxes through the separation member 2100 but permit passage of mosquito salivary glands through the separation member 2100 during rotation of the separation member 2100.

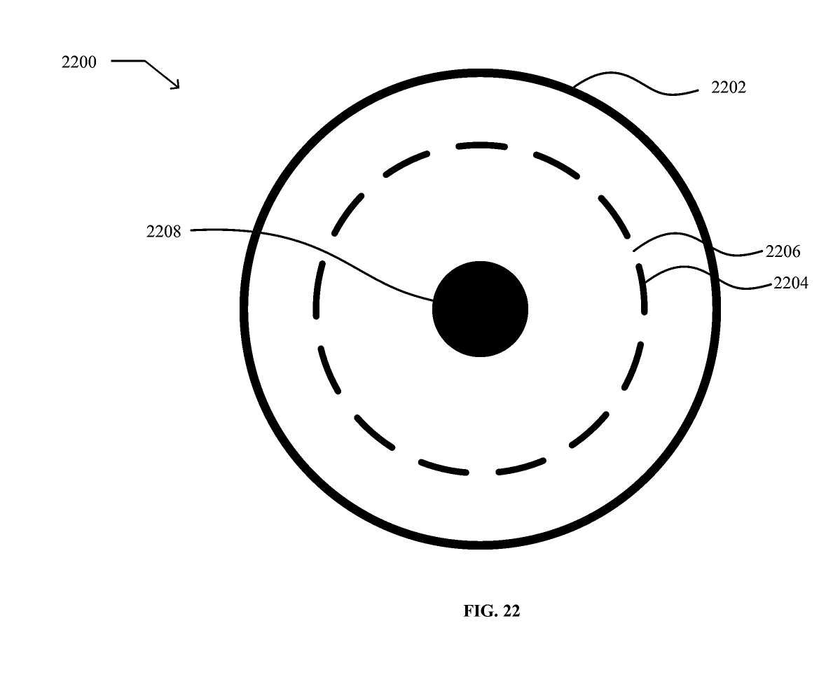

FIG. 22 illustrates a cross-sectional top view of a rotor 2200. Rotor 2200 includes a rotor body 2202 to which a separation member 2204 is operably coupled. The separation member 2204 includes solid portions and spaces 2206 that pass through the separation member 2204. Rotor 2200 is configured to operably associate with a centrifuge drive spindle 2208. In some embodiments, rotor 2200 may include a separation member 2204 that may be configured to provide for separation of bodily parts from an insect. In some embodiments, the spaces 2206 may be configured for use with a mosquito. For example, in some embodiments, the spaces 2206 may be sized and shaped to disallow passage of mosquito thoraxes through the separation member 2204 but permit passage of mosquito salivary glands through the separation member 2204 during rotation of the rotor 2200.

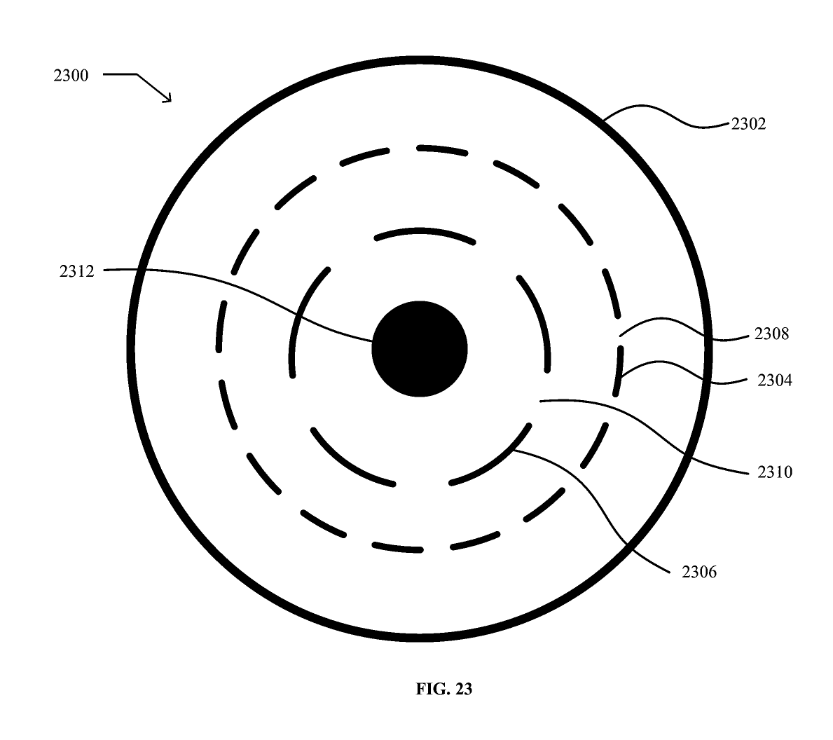

FIG. 23 illustrates a cross-sectional top view of a rotor 2300. Rotor 2300 includes a rotor body 2302 to which a first separation member 2304 and a second separation member 2306 are operably coupled. The first separation member 2304 includes solid portions 2304 and spaces 2308 that pass through the first separation member 2304. The second separation member 2306 includes solid portions 2306 and spaces 2310 that pass through the second separation member 2306. The first separation member 2304 and the second separation member 2306 are shown as having spaces (2308 and 2310) of different sizes with the spaces 2310 in the second separation member 2306 being larger. Accordingly, in some embodiments, rotor 2300 may be used to separate multiple components contained within a sample based on the sizes of the components. Rotor 2300 is configured to operably associate with a centrifuge drive spindle 2312. In some embodiments, rotor 2300 may include a first separation member 2304 and a second separation member 2306 that may be configured to provide for separation of bodily parts from an insect. In some embodiments, the first separation member 2304 and the second separation member 2306 may be configured for use with a mosquito. For example, in some embodiments, the spaces 2308 that pass through the first separation member 2304 may be sized and shaped to disallow passage of mosquito thoraxes through the first separation member 2304 but permit passage of mosquito salivary glands through the first separation member 2304 during rotation of the rotor 2300. In some embodiments, the spaces 2310 that pass through the second separation member 2306 may be sized and shaped to disallow passage of fully intact mosquitos through the second separation member 2306 but permit passage of mosquito thoraxes through the second separation member 2306 during rotation of the rotor 2300.

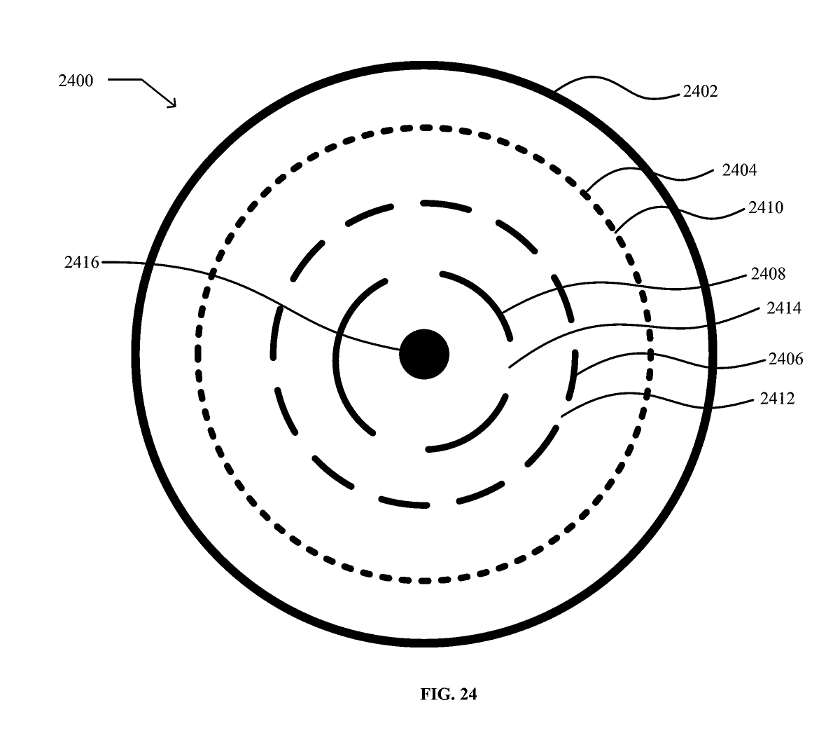

FIG. 24 illustrates a cross-sectional top view of a rotor 2400. Rotor 2400 includes a rotor body 2402 to which a first separation member 2404, a second separation member 2406, and a third separation member 2408 are operably coupled. The first separation member 2404 includes solid portions 2404 and spaces 2410 that pass through the first separation member 2404. The second separation member 2406 includes solid portions 2406 and spaces 2412 that pass through the second separation member 2406. The third separation member 2408 includes solid portions 2408 and spaces 2414 that pass through the third separation member 2408. The first separation member 2404, the second separation member 2406, and the third separation member 2408 are shown as having spaces (2410, 2412, and 2414) of different sizes with the spaces becoming progressively smaller toward the outside of rotor 2400. Accordingly, in some embodiments, rotor 2400 may be used to separate multiple components contained within a sample based on the sizes of the components. Rotor 2400 is configured to operably associate with a centrifuge drive spindle 2416. In some embodiments, rotor 2400 may include a first separation member 2404, a second separation member 2406, and a third separation member 2408 that may be configured to provide for separation of bodily parts from an insect. In some embodiments, the first separation member 2404, a second separation member 2406, and a third separation member 2408 may be configured for use with a mosquito. For example, in some embodiments, the spaces 2410 that pass through the first separation member 2404 may be sized and shaped to disallow passage of mosquito salivary glands through the first separation member 2404 but permit passage of sporozoites through the first separation member 2404 during rotation of the rotor 2400. In some embodiments, the spaces 2412 that pass through the second separation member 2406 may be sized and shaped to disallow passage of mosquito thoraxes through the second separation member 2406 but permit passage of mosquito salivary glands through the second separation member 2406 during rotation of the rotor 2400. In some embodiments, the spaces 2414 that pass through the third separation member 2408 may be sized and shaped to disallow passage of fully intact mosquitos through the third separation member 2408 but permit passage of mosquito thoraxes through the third separation member 2408 during rotation of the rotor 2400

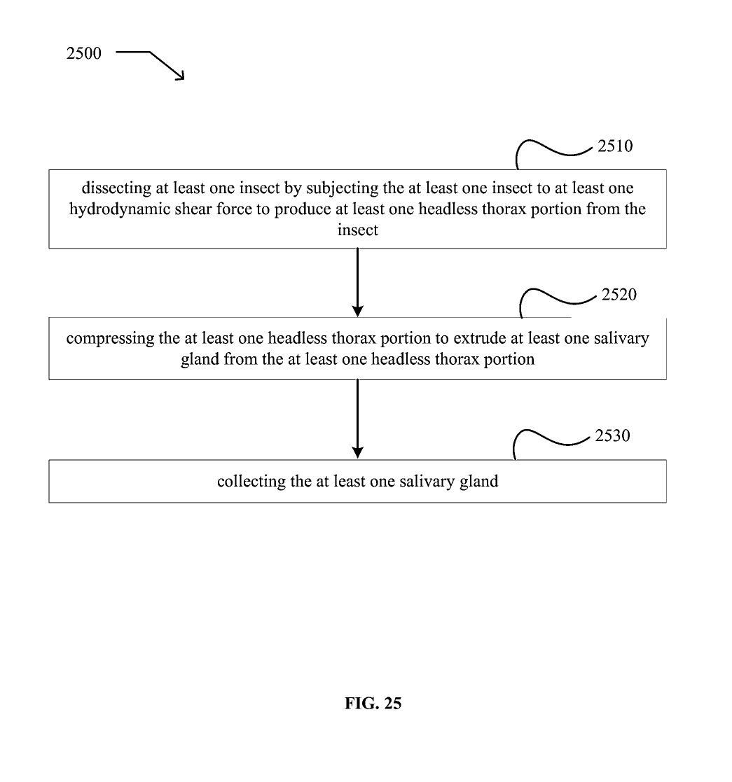

FIG. 25 illustrates operational flow 2500 that includes operation 2510 that includes dissecting at least one insect by subjecting the at least one insect to at least one hydrodynamic shear force to produce at least one headless thorax portion from the insect, operation 1320 that includes compressing the at least one headless thorax portion to extrude at least one salivary gland from the at least one headless thorax portion, and operation 1330 that includes collecting the at least one salivary gland.

In FIG. 25 and in the following description that includes various examples of operations used during performance of the method, discussion and explanation may be provided with respect to any one or combination of the above-described examples, and/or with respect to other examples and contexts. However, it should be understood that the operations may be executed in a number of other environments and contexts, and/or modified versions of the figures. Also, although the various operations are presented in the sequence(s) illustrated, it should be understood that the various operations may be performed in other orders than those which are illustrated, or may be performed concurrently.

Operation 2510 includes dissecting at least one insect by subjecting the at least one insect to at least one hydrodynamic shear force to produce at least one headless thorax portion from the insect. In some embodiments, a dissection unit 102 may be used to subject at least one insect to at least one hydrodynamic shear force to produce at least one headless thorax portion from the insect. In some embodiments, a dissection unit 102 may be used to subject at least one insect to at least one tensile force. In some embodiments, one or more insects may be suspended in a fluid or a combination of fluids and then forced through a constriction region that produces hydrodynamic shear force. In some embodiments, the flow of the fluid can be laminar flow prior to a constriction region and turbulent after the constriction region. In some embodiments, one or more insects may be suspended in a fluid or a combination of fluids and then forced through a hydrodynamic cavitation device that produces hydrodynamic shear force (e.g., McGuire et al., Hydrodynamic cavitation device, Published U.S. Patent Application: 20130088935, herein incorporated by reference). An insect may be suspended in numerous types of fluids and combinations of fluids. Examples of such fluids include, but are not limited to, hydrophilic fluids, hydrophobic fluids, aqueous fluids, buffers, solvents, and the like. In some embodiments, an insect is subjected to hydrodynamic shear force to remove the head portion from the thorax portion of the insect. In some embodiments, an insect is subjected to hydrodynamic shear force to remove the head portion and one or more legs from the thorax portion of the insect. In some embodiments, an insect is subjected to hydrodynamic shear force to remove the head portion and one or more wings from the thorax portion of the insect. In some embodiments, an insect is subjected to hydrodynamic shear force to remove the head portion and one or more legs and one or more wings from the thorax portion of the insect. In some embodiments, an insect is subjected to hydrodynamic shear force to remove the head portion and the abdominal portion from the thorax portion of the insect. In some embodiments, an insect is subjected to hydrodynamic shear force to remove the head portion, one or more legs, one or more wings, and the abdominal portion from the thorax portion of the insect. In some embodiments, an insect is subjected to hydrodynamic shear force to remove the head portion, all of the legs, all of the wings, and the abdominal portion from the thorax portion of the insect. In some embodiments, the operation of a dissection unit 102 may depend upon the extent to which one or more insects are dissected. For example, in some embodiments, a dissection unit 102 may operate to dissect one or more insects until the head portions are removed from the thorax portions of at least forty percent of the insects. In some embodiments, a dissection unit 102 may operate to dissect one or more insects until the head portions are removed from the thorax portions of at least fifty percent of the insects. In some embodiments, a dissection unit 102 may operate to dissect one or more insects until the head portions are removed from the thorax portions of at least sixty percent of the insects. In some embodiments, a dissection unit 102 may operate to dissect one or more insects until the head portions are removed from the thorax portions of at least seventy percent of the insects. In some embodiments, a dissection unit 102 may operate to dissect one or more insects until the head portions are removed from the thorax portions of at least eighty percent of the insects. In some embodiments, a dissection unit 102 may operate to dissect one or more insects until the head portions are removed from the thorax portions of at least ninety percent of the insects. In some embodiments, a dissection unit 102 may operate to dissect one or more insects until the head portions are removed from the thorax portions of at least ninety five percent of the insects. In some embodiments, a dissection unit 102 may operate to dissect one or more insects until the head portions are removed from the thorax portions of at least one hundred percent of the insects. In some embodiments, a dissection unit 102 may similarly operate to dissect one or more insects until a selected percentage of legs are removed from the thorax portions of the one or more insects. In some embodiments, a dissection unit 102 may similarly operate to dissect one or more insects until a selected percentage of wings are removed from the thorax portions of the one or more insects. In some embodiments, a dissection unit 102 may similarly operate to dissect one or more insects until a selected percentage of abdominal portions are removed from the thorax portions of the one or more insects. In some embodiments, a dissection unit 102 may similarly operate to dissect one or more insects until a selected percentage of legs, wings, and abdominal portions are removed from the thorax portions of the one or more insects. In some embodiments, one or more imaging apparatuses 104 may be configured to acquire one or more images of one or more insects that are being dissected in a dissection unit 102. The one or more images may be processed to determine the percentage of insects that have been dissected. For example, in some embodiments, the percentage of insects from which the head portion has been dissected from the thorax portion of the insect may be determined. Accordingly, such a determination may be used to control the operation of a dissection unit 102. For example, a dissection unit 102 may be set to operate until the head portion has been removed from the thorax portion of at least eighty percent of insects being dissected in the dissection unit 102. Accordingly, one or more imaging apparatuses 104 and a dissection unit 102 may operate through a feedback loop that controls the operation of the dissection unit 102 in response to images acquired by the one or more imaging apparatuses 104.

Operation 2520 includes compressing the at least one headless thorax portion to extrude at least one salivary gland from the at least one headless thorax portion. In some embodiments, a headless thorax portion of an insect may be compressed to extrude a salivary gland from the headless thorax portion of the insect. Numerous methods may be used to compress one or more headless thorax portions from one or more insects to extrude one or more salivary glands. In some embodiments, two or more plates may be used to compress one or more headless thorax portions from one or more insects. For example, in some embodiments, one or more headless insect thoraxes may be placed between two glass plates and then compressed to extrude one or more salivary glands. In some embodiments, one or more headless insect thoraxes may be placed within a separation member of a centrifuge rotor and then compressed to extrude one or more salivary glands into the interior of the separation member of the centrifuge rotor. In some embodiments, one or more headless insect thoraxes may be placed within a separation member of a centrifuge rotor and then centrifuged to extrude one or more salivary glands from the one or more headless thorax portions of one or more insects. In some embodiments, one or more headless insect thoraxes may be placed on a screen and then compressed with a plate to extrude one or more salivary glands through the screen. In some embodiments, such compression may be regulated in response to one or more images acquired by one or more imaging apparatuses 104.

Operation 2530 includes collecting the at least one salivary gland. In some embodiments, one or more insect salivary glands may be collected. Numerous methods may be used to collect one or more insect salivary glands. In some embodiments, one or more insect salivary glands may be collected through use of suction. For example, in some embodiments, a suction apparatus may be attached to a Pasteur pipette that may then be used to collect one or more insect salivary glands. In some embodiments, one or more insect salivary glands may be collected manually. For example, in some embodiments, a user 112 may scrape one or more insect salivary glands that have been extruded onto a plate. In some embodiments, a user 112 may scrape one or more insect salivary glands that have been extruded onto a glass plate. In some embodiments, a user 112 may scrape one or more insect salivary glands that have been extruded through a screen. In some embodiments, one or more imaging apparatuses 104 may be used to verify collection of one or more insect salivary glands.

In some embodiments, operation 2510 includes dissecting at least one mosquito by subjecting the at least one mosquito to the at least one hydrodynamic shear force to produce at least one headless thorax portion from the at least one mosquito (not shown). In some embodiments, a dissection unit 102 may be used to dissect a mosquito by subjecting the mosquito to hydrodynamic shear force to produce a headless thorax portion from the mosquito. In some embodiments, a mosquito may be suspended in a fluid or combination of fluids that is forced through a constriction region to produce hydrodynamic shear force to dissect the mosquito. In some embodiments, a mosquito may be suspended in a fluid or combination of fluids that is forced through a hydrodynamic shear member 142 to produce hydrodynamic shear force to dissect the mosquito. In some embodiments, a mosquito may be suspended in a fluid or combination of fluids that is forced through a hydrodynamic shear member 142 that is configured as a hydrodynamic cavitation device to produce hydrodynamic shear force to dissect the mosquito. In some embodiments, a mosquito may be dissected to extract one or more salivary glands that include one or more sporozoites from the mosquito. Accordingly, in some embodiments, a mosquito may be dissected in order to isolate sporozoites from the mosquito.

In some embodiments, operation 2510 includes dissecting at least one bee by subjecting the at least one bee to the at least one hydrodynamic shear force to produce at least one headless thorax portion from the at least one bee. In some embodiments, a dissection unit 102 may be used to dissect a bee by subjecting the bee to hydrodynamic shear force to produce a headless thorax portion from the bee. In some embodiments, a bee may be suspended in a fluid or combination of fluids that is forced through a constriction region to produce hydrodynamic shear force to dissect the bee. In some embodiments, a bee may be suspended in a fluid or combination of fluids that is forced through a hydrodynamic shear member 142 to produce hydrodynamic shear force to dissect the bee. In some embodiments, a bee may be suspended in a fluid or combination of fluids that is forced through a hydrodynamic shear member 142 that is configured as a hydrodynamic cavitation device to produce hydrodynamic shear force to dissect the bee. In some embodiments, a bee may be dissected to extract one or more salivary glands from the bee.

In some embodiments, operation 2510 includes dissecting at least one wasp by subjecting the at least one wasp to the at least one hydrodynamic shear force to produce at least one headless thorax portion from the at least one wasp. In some embodiments, a dissection unit 102 may be used to dissect a wasp by subjecting the wasp to hydrodynamic shear force to produce a headless thorax portion from the wasp. In some embodiments, a wasp may be suspended in a fluid or combination of fluids that is forced through a constriction region to produce hydrodynamic shear force to dissect the wasp. In some embodiments, a wasp may be suspended in a fluid or combination of fluids that is forced through a hydrodynamic shear member 142 to produce hydrodynamic shear force to dissect the wasp. In some embodiments, a wasp may be suspended in a fluid or combination of fluids that is forced through a hydrodynamic shear member 142 that is configured as a hydrodynamic cavitation device to produce hydrodynamic shear force to dissect the wasp. In some embodiments, a wasp may be dissected to extract one or more salivary glands from the wasp.

In some embodiments, operation 2510 includes dissecting at least one cricket by subjecting the at least one cricket to the at least one hydrodynamic shear force to produce at least one headless thorax portion from the at least one cricket. In some embodiments, a dissection unit 102 may be used to dissect a cricket by subjecting the cricket to hydrodynamic shear force to produce a headless thorax portion from the cricket. In some embodiments, a cricket may be suspended in a fluid or combination of fluids that is forced through a constriction region to produce hydrodynamic shear force to dissect the cricket. In some embodiments, a cricket may be suspended in a fluid or combination of fluids that is forced through a hydrodynamic shear member 142 to produce hydrodynamic shear force to dissect the cricket. In some embodiments, a cricket may be suspended in a fluid or combination of fluids that is forced through a hydrodynamic shear member 142 that is configured as a hydrodynamic cavitation device to produce hydrodynamic shear force to dissect the cricket. In some embodiments, a cricket may be dissected to extract one or more salivary glands from the cricket.

In some embodiments, operation 2510includes dissecting at least one fruit fly by subjecting the at least one fruit fly to the at least one hydrodynamic shear force to produce at least one headless thorax portion from the at least one fruit fly. In some embodiments, a dissection unit 102 may be used to dissect a fruit fly by subjecting the fruit fly to hydrodynamic shear force to produce a headless thorax portion from the fruit fly. In some embodiments, a fruit fly may be suspended in a fluid or combination of fluids that is forced through a constriction region to produce hydrodynamic shear force to dissect the fruit fly. In some embodiments, a fruit fly may be suspended in a fluid or combination of fluids that is forced through a hydrodynamic shear member 142 to produce hydrodynamic shear force to dissect the fruit fly. In some embodiments, a fruit fly may be suspended in a fluid or combination of fluids that is forced through a hydrodynamic shear member 142 that is configured as a hydrodynamic cavitation device to produce hydrodynamic shear force to dissect the fruit fly. In some embodiments, a fruit fly may be dissected to extract one or more salivary glands from the fruit fly.

In some embodiments, operation 2510includes dissecting at least one beetle by subjecting the at least one beetle to the at least one hydrodynamic shear force to produce at least one headless thorax portion from the at least one beetle. In some embodiments, a dissection unit 102 may be used to dissect a beetle by subjecting the beetle to hydrodynamic shear force to produce a headless thorax portion from the beetle. In some embodiments, a beetle may be suspended in a fluid or combination of fluids that is forced through a constriction region to produce hydrodynamic shear force to dissect the beetle. In some embodiments, a beetle may be suspended in a fluid or combination of fluids that is forced through a hydrodynamic shear member 142 to produce hydrodynamic shear force to dissect the beetle. In some embodiments, a beetle may be suspended in a fluid or combination of fluids that is forced through a hydrodynamic shear member 142 that is configured as a hydrodynamic cavitation device to produce hydrodynamic shear force to dissect the beetle. In some embodiments, a beetle may be dissected to extract one or more salivary glands from the beetle.

In some embodiments, operation 2510 includes dissecting at least one tick by subjecting the at least one tick to the at least one hydrodynamic shear force to produce at least one headless thorax portion from the at least one tick. In some embodiments, a dissection unit 102 may be used to dissect a tick by subjecting the tick to hydrodynamic shear force to produce a headless thorax portion from the tick. In some embodiments, a tick may be suspended in a fluid or combination of fluids that is forced through a constriction region to produce hydrodynamic shear force to dissect the tick. In some embodiments, a tick may be suspended in a fluid or combination of fluids that is forced through a hydrodynamic shear member 142 to produce hydrodynamic shear force to dissect the tick. In some embodiments, a tick may be suspended in a fluid or combination of fluids that is forced through a hydrodynamic shear member 142 that is configured as a hydrodynamic cavitation device to produce hydrodynamic shear force to dissect the tick. In some embodiments, a tick may be dissected to extract one or more salivary glands from the tick.

In some embodiments, operation 2510includes forcing a fluid that contains the at least one insect through a constriction region that produces the at least one hydrodynamic shear force. In some embodiments, a dissection unit 102 may be used to force a fluid that contains an insect through a constriction region that produces hydrodynamic shear force to dissect the insect. In some embodiments, a fluid that contains one or more insects may be forced through a constriction region that produces hydrodynamic shear force through the action of one or more pumps 116. For example, in some embodiments, the fluid containing the one or more insects may be included within a fluid reservoir 134 that is configured as a loop of tubing that includes a constriction region that produces hydrodynamic shear force when the fluid is forced through the constriction region by one or more pumps 116. In some embodiments, a dissection unit 102 may be used to force a fluid that contains an insect back and forth between two or more fluid reservoirs 134 that are connected through a constriction region that produces hydrodynamic shear force to dissect the insect (e.g., FIGS. 10-13).

In some embodiments, operation 2510 includes forcing a fluid that contains the at least one insect back and forth between at least two fluid reservoirs 134 that are fluidly coupled through a constriction region that produces the at least one hydrodynamic shear force (not shown). In some embodiments, a dissection unit 102 may be used to force a fluid that contains an insect back and forth between at least two fluid reservoirs 134 that are fluidly coupled through a constriction region that produces hydrodynamic shear force to dissect the insect (e.g., FIGS. 10-13). In some embodiments, two syringes 136 may be coupled together through a reservoir coupling 138 that includes a constriction region that produces hydrodynamic shear force when fluid is forced through the hydrodynamic shear member (e.g., FIGS. 4 and 5). For example, in some embodiments, two syringes 136 may be coupled together through a luer lock coupling. Accordingly, fluid that contains one or more insects may be forced back and forth between the two syringes 136 through the luer lock coupling to dissect the one or more insects. In some embodiments, fluid that contains one or more mosquitos may be forced back and forth between the two syringes 136 through the luer lock coupling to dissect the one or more mosquitos.

In some embodiments, operation 2510 includes forcing a fluid that contains the at least one insect through a hydrodynamic shear member that produces the at least one hydrodynamic shear force (not shown). In some embodiments, a dissection unit 102 may be used to force a fluid that contains an insect through a hydrodynamic shear member that produces hydrodynamic shear force to dissect the insect. In some embodiments, a fluid that contains one or more insects may be forced through a hydrodynamic shear member 142 through the action of one or more pumps 116. For example, in some embodiments, the fluid containing the one or more insects may be included within a fluid reservoir 134 that is configured as a loop of tubing that is continuously connected with a hydrodynamic shear member 142 such that a pump 116 may be used to force the fluid through the hydrodynamic shear member (e.g., FIGS. 8 and 9). In some embodiments, two syringes 136 may be coupled together through a hydrodynamic shear member 142 that is configured as a hydrodynamic cavitation device that produces hydrodynamic shear force when fluid is forced through the hydrodynamic shear member (e.g., FIGS. 6 and 7). In some embodiments, a dissection unit 102 may be used to force a fluid that contains a mosquito through a hydrodynamic shear member 142 that produces hydrodynamic shear force to dissect the mosquito.

In some embodiments, operation 2510 includes subjecting the at least one insect to hydrodynamic shear force to separate a head portion from a thorax portion of the at least one insect to produce the at least one headless thorax portion. In some embodiments, a dissection unit 102 may be used to subject an insect to hydrodynamic shear force to separate a head portion from a thorax portion of the insect to produce at least one headless thorax portion of the insect. In some embodiments, a dissection unit 102 may operate with one or more imaging apparatuses 104 to separate a head portion from a thorax portion of an insect. For example, in some embodiments, an imaging apparatus 104 may acquire one or more images of one or more insects that are being dissected in a dissection unit 102. In some embodiments, the one or more images may then be processed to determine the extent to which head portions are removed from thorax portions of the one or more insects that are being dissected. In some embodiments, the operation of a dissection unit 102 may then be controlled in response to the extent to which head portions are removed from thorax portions of the one or more insects. Accordingly, in some embodiments, the level of operation of one or more pumps 116 may be increased, decreased, maintained, or stopped. In some embodiments, the level of operation of one or more motors 120 may be increased, decreased, maintained, or stopped. In some embodiments, a dissection unit 102 may be used to subject a mosquito to hydrodynamic shear force to separate a head portion from a thorax portion of the mosquito to produce at least one headless thorax portion of the mosquito.

In some embodiments, operation 2510includes subjecting the at least one insect to the at least one hydrodynamic shear force to produce at least one substantially intact headless thorax portion from the insect. In some embodiments, a dissection unit 102 may be used to subject an insect to hydrodynamic shear force to produce a substantially intact headless thorax portion from the insect. In some embodiments, a dissection unit 102 may operate with one or more imaging apparatuses 104 to produce a substantially intact headless thorax portion from an insect. For example, in some embodiments, an imaging apparatus 104 may acquire one or more images of one or more insects that are being dissected in a dissection unit 102. In some embodiments, the one or more images may then be processed to determine the extent to which substantially intact headless thorax portions of the one or more insects are being produced. In some embodiments, the operation of a dissection unit 102 may then be controlled in response to the extent to which substantially intact headless thorax portions of the one or more insects are being produced. Accordingly, in some embodiments, the level of operation of one or more pumps 116 may be increased, decreased, maintained, or stopped. In some embodiments, the level of operation of one or more motors 120 may be increased, decreased, maintained, or stopped. In some embodiments, a dissection unit 102 may be used to subject a mosquito to hydrodynamic shear force to produce a substantially intact headless thorax portion from the mosquito.

In some embodiments, operation 2510 includes subjecting the at least one insect to the at least one hydrodynamic shear force to separate an abdominal portion from the thorax portion of the insect. In some embodiments, a dissection unit 102 may be used to subject an insect to hydrodynamic shear force to separate an abdominal portion from the thorax portion of the insect. In some embodiments, a dissection unit 102 may operate with one or more imaging apparatuses 104 to separate an abdominal portion from the thorax portion of the insect. For example, in some embodiments, an imaging apparatus 104 may acquire one or more images of one or more insects that are being dissected in a dissection unit 102. In some embodiments, the one or more images may then be processed to determine the extent to which abdominal portions are separated from thorax portions of one or more insects. In some embodiments, the operation of a dissection unit 102 may then be controlled in response to the extent to which abdominal portions are separated from thorax portions of one or more insects. Accordingly, in some embodiments, the level of operation of one or more pumps 116 may be increased, decreased, maintained, or stopped. In some embodiments, the level of operation of one or more motors 120 may be increased, decreased, maintained, or stopped. In some embodiments, a dissection unit 102 may be used to separate an abdominal portion from a thorax portion of one or more mosquitos.

In some embodiments, operation 2510 includes subjecting the at least one insect to the at least one hydrodynamic shear force to separate at least one wing from the thorax portion of the insect. In some embodiments, a dissection unit 102 may be used to subject an insect to hydrodynamic shear force to separate at least one wing from the thorax portion of an insect. In some embodiments, a dissection unit 102 may operate with one or more imaging apparatuses 104 to separate at least one wing from a thorax portion of an insect. For example, in some embodiments, an imaging apparatus 104 may acquire one or more images of one or more insects that are being dissected in a dissection unit 102. In some embodiments, the one or more images may then be processed to determine the extent to which at least one wing is separated from thorax portions of one or more insects. In some embodiments, the operation of a dissection unit 102 may then be controlled in response to the extent to which at least one wing is separated from thorax portions of one or more insects. Accordingly, in some embodiments, the level of operation of one or more pumps 116 may be increased, decreased, maintained, or stopped. In some embodiments, the level of operation of one or more motors 120 may be increased, decreased, maintained, or stopped. In some embodiments, a dissection unit 102 may be used to separate at least one wing from a thorax portion of one or more mosquitos.

In some embodiments, operation 2510 includes subjecting the at least one insect to the at least one hydrodynamic shear force to separate at least one leg from the thorax portion of the insect. In some embodiments, a dissection unit 102 may be used to subject an insect to hydrodynamic shear force to separate at least one leg from the thorax portion of an insect. In some embodiments, a dissection unit 102 may operate with one or more imaging apparatuses 104 to separate at least one leg from a thorax portion of an insect. For example, in some embodiments, an imaging apparatus 104 may acquire one or more images of one or more insects that are being dissected in a dissection unit 102. In some embodiments, the one or more images may then be processed to determine the extent to which at least one leg is separated from thorax portions of one or more insects. In some embodiments, the operation of a dissection unit 102 may then be controlled in response to the extent to which at least one leg is separated from thorax portions of one or more insects. Accordingly, in some embodiments, the level of operation of one or more pumps 116 may be increased, decreased, maintained, or stopped. In some embodiments, the level of operation of one or more motors 120 may be increased, decreased, maintained, or stopped. In some embodiments, a dissection unit 102 may be used to separate at least one leg from a thorax portion of one or more mosquitos.

In some embodiments, operation 2510 includes subjecting the at least one insect to the at least one hydrodynamic shear force to separate an abdominal portion, at least one leg, and at least one wing to produce at least one substantially intact headless thorax portion from the insect. In some embodiments, a dissection unit 102 may be used to subject an insect to hydrodynamic shear force to separate an abdominal portion, at least one leg, and at least one wing to produce a substantially intact headless thorax portion from the insect. In some embodiments, a dissection unit 102 may operate with one or more imaging apparatuses 104 to separate an abdominal portion, at least one leg, and at least one wing from a thorax portion of an insect to produce a substantially intact headless thorax portion from the insect. For example, in some embodiments, an imaging apparatus 104 may acquire one or more images of one or more insects that are being dissected in a dissection unit 102. In some embodiments, the one or more images may then be processed to determine the extent to which an abdominal portion, at least one leg, and at least one wing have been separated from a thorax portion of an insect to produce a substantially intact headless thorax portion from the insect. In some embodiments, the operation of a dissection unit 102 may then be controlled in response to the extent to which an abdominal portion, at least one leg, and at least one wing have been separated from a thorax portion of an insect to produce a substantially intact headless thorax portion from the insect. Accordingly, in some embodiments, the level of operation of one or more pumps 116 may be increased, decreased, maintained, or stopped. In some embodiments, the level of operation of one or more motors 120 may be increased, decreased, maintained, or stopped. In some embodiments, a dissection unit 102 may be used to separate an abdominal portion, at least one leg, and at least one wing from a thorax portion of a mosquito to produce a substantially intact headless thorax portion from the mosquito.

In some embodiments, operation 2510 includes subjecting the at least one insect to the at least one hydrodynamic shear force to separate an abdominal portion, all legs, and all wings from the insect to produce at least one substantially intact headless thorax portion from the insect. In some embodiments, a dissection unit 102 may be used to subject an insect to hydrodynamic shear force to separate an abdominal portion, all legs, and all wings to produce a substantially intact headless thorax portion from the insect. In some embodiments, a dissection unit 102 may operate with one or more imaging apparatuses 104 to separate an abdominal portion, all legs, and all wings from a thorax portion of an insect to produce a substantially intact headless thorax portion from the insect. For example, in some embodiments, an imaging apparatus 104 may acquire one or more images of one or more insects that are being dissected in a dissection unit 102. In some embodiments, the one or more images may then be processed to determine the extent to which an abdominal portion, legs, and wings have been separated from a thorax portion of an insect to produce a substantially intact headless thorax portion from the insect. In some embodiments, the operation of a dissection unit 102 may then be controlled in response to the extent to which an abdominal portion, legs, and wings have been separated from a thorax portion of an insect to produce a substantially intact headless thorax portion from the insect. Accordingly, in some embodiments, the level of operation of one or more pumps 116 may be increased, decreased, maintained, or stopped. In some embodiments, the level of operation of one or more motors 120 may be increased, decreased, maintained, or stopped. In some embodiments, a dissection unit 102 may be used to separate an abdominal portion, all legs, and all wings from a thorax portion of a mosquito to produce a substantially intact headless thorax portion from the mosquito.

In some embodiments, operation 2510 includes substantially isolating the at least one headless thorax portion from the at least one insect. In some embodiments, a headless thorax portion from an insect may be substantially isolated. Numerous methods may be used to substantially isolate a headless thorax portion from an insect. In some embodiments, a series of screens having pores of varying sizes may be used to substantially isolate a headless thorax portion from an insect. For example, a mixture of fully intact and partially dissected insects may be placed onto a first screen having pores that are too small to allow passage of a fully intact insect through the first screen but that are large enough to allow passage of a partially dissected insect through the first screen. Partially dissected insects may pass through the first screen and be deposited onto a second screen having pores that are too small to allow passage of a partially dissected insect that includes an abdominal portion but that are large enough to allow passage of a partially dissected insect from which the abdominal portion has been separated. Accordingly, in some embodiments, screens may be selected that may be used to substantially isolate a headless thorax portion from an insect.

In some embodiments, operation 2510 includes substantially isolating the at least one headless thorax portion from the at least one insect through use of gel filtration chromatography. In some embodiments, gel filtration chromatography may be used to substantially isolate a headless thorax portion from an insect.

In some embodiments, operation 2510 includes substantially isolating the at least one headless thorax portion from the at least one insect through use of centrifugation. In some embodiments, centrifugation may be used to substantially isolate a headless thorax portion from an insect. In some embodiments, velocity centrifugation may be used to substantially isolate a headless thorax portion from an insect. In some embodiments, a headless thorax portion from an insect may be substantially isolated through use of a centrifuge rotor that includes a separation member (e.g., FIGS. 14-17). For example, in some embodiments, a mixture of fully intact and partially dissected insects may be deposited on the interior of a separation member that allows passage of partially dissected insects through the pores of the separation member but disallows passage of fully intact insects through the separation member. Accordingly, in some embodiments, one or more separation members may be selected that provide for the substantial isolation of a headless thorax portion from an insect. In some embodiments, centrifugation may be used to substantially isolate a headless thorax portion from a mosquito.

In some embodiments, operation 2520 includes compressing the at least one headless thorax portion between at least two plates. In some embodiments, a headless thorax portion of an insect may be compressed between at least two plates. In some embodiments, a headless thorax portion of a mosquito may be compressed between at least two plates. In some embodiments, a headless thorax portion of an insect may be compressed between at least two plates to extrude one or more salivary glands from the headless thorax portion. In some embodiments, a headless thorax portion of an insect may be compressed between at least two glass plates. In some embodiments, a headless thorax portion of an insect may be compressed between a metal plate and a glass plate.

In some embodiments, operation 2520 includes compressing the at least one headless thorax portion against a screen. In some embodiments, a headless thorax portion of an insect may be compressed against a screen. In some embodiments, a headless thorax portion of a mosquito may be compressed against a screen. In some embodiments, a headless thorax portion of an insect may be compressed against a screen to extrude one or more salivary glands from the headless thorax portion of an insect. In some embodiments, a headless thorax portion of an insect may be compressed against a screen to extrude one or more salivary glands from the headless thorax portion and push the salivary glands through the screen. Accordingly, in some embodiments, the salivary glands may be collected from the screen.

In some embodiments, operation 2520 includes centrifuging the at least one headless thorax portion. In some embodiments, a headless thorax portion of an insect may be centrifuged. In some embodiments, a headless thorax portion of a mosquito may be centrifuged. In some embodiments, a headless thorax portion of an insect may be centrifuged to extrude one or more salivary glands from the headless thorax portion. In some embodiments, a headless thorax portion from an insect may be centrifuged in a centrifuge rotor that includes a separation member (e.g., FIGS. 14-17). For example, in some embodiments, a headless thorax portion may be deposited on the interior of a separation member that allows passage of salivary glands through the pores of the separation member but disallows passage of the thorax portion of the insect through the pores of the separation member. Accordingly, in some embodiments, one or more separation members may be selected that provide for the substantial isolation of salivary glands from a headless thorax portion of an insect. In some embodiments, centrifugation may be used to substantially isolate salivary glands from a headless thorax portion of a mosquito.

In some embodiments, operation 2520 includes collecting the one or more salivary glands through use of suction. In some embodiments, one or more salivary glands may be collected through use of suction. For example, in some embodiments, a suction apparatus may be attached to a Pasteur pipette that may then be used to collect one or more insect salivary glands.

In some embodiments, operation 2520 includes manually collecting the one or more salivary glands. In some embodiments, one or more insect salivary glands may be collected manually. In some embodiments, one or more mosquito salivary glands may be collected manually. For example, in some embodiments, a user 112 may scrape one or more insect salivary glands that have been extruded onto a plate. In some embodiments, a user 112 may scrape one or more insect salivary glands that have been extruded onto a glass plate. In some embodiments, a user 112 may scrape one or more insect salivary glands that have been extruded through a screen.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware in one or more machines, compositions of matter, and articles of manufacture, limited to patentable subject matter under 35 USC 101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include computer programs or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operation described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof, limited to patentable subject matter under 35 U.S.C. 101. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, limited to patentable subject matter under 35 U.S.C. 101, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof, limited to patentable subject matter under 35 U.S.C. 101; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces 110, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

Although user 112 is described herein as a single individual, those skilled in the art will appreciate that user 112 may be representative of a human user, a robotic user (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

All publications, patents and patent applications cited herein are incorporated herein by reference. The foregoing specification has been described in relation to certain embodiments thereof, and many details have been set forth for purposes of illustration, however, it will be apparent to those skilled in the art that the invention is susceptible to additional embodiments and that certain of the details described herein may be varied considerably without departing from the basic principles of the invention.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A device comprising:
two or more fluid reservoirs that are operably coupled to allow fluid flow between the two or more fluid reservoirs through one or more hydrodynamic shear members;
two or more fluid displacement members that are each individually moveably coupled within each of the two or more fluid reservoirs;
one or more drive mechanisms that are operably coupled to each of the two or more fluid displacement members and configured to move each of the two or more operably coupled fluid displacement members in coordinated opposition to each other within each of the two or more fluid reservoirs; and
one or more control units that are configured to control operation of the one or more drive mechanisms.

2. (canceled)

3. The device of claim 1, wherein the two or more fluid reservoirs that are operably coupled to allow fluid flow between the two or more fluid reservoirs through one or more hydrodynamic shear members comprise:
two or more fluid reservoirs that are operably coupled through one or more hydrodynamic shear members that are constriction couplings.

4. The device of claim 1, wherein the two or more fluid reservoirs that are operably coupled to allow fluid flow between the two or more fluid reservoirs through one or more hydrodynamic shear members comprise:
two or more fluid reservoirs that are operably coupled through one or more hydrodynamic shear members that are cavitation devices.

5-7. (canceled)

8. The device of claim 1, wherein the one or more drive mechanisms that are operably coupled to each of the two or more fluid displacement members and configured to move each of the two or more operably coupled fluid displacement members in coordinated opposition to each other within each of the two or more fluid reservoirs comprise:
at least one motor.

9-11. (canceled)

12. The device of claim 1, wherein the one or more drive mechanisms that are operably coupled to each of the two or more fluid displacement members and configured to move each of the two or more operably coupled fluid displacement members in coordinated opposition to each other within each of the two or more fluid reservoirs comprise:
at least one actuator that is operably coupled to at least one motor.

13-16. (canceled)

17. The device of claim 1, wherein the one or more control units that are configured to control operation of the one or more drive mechanisms comprise:
one or more control databases that include one or more images of one or more insects.

18. The device of claim 1, wherein the one or more control units that are configured to control operation of the one or more drive mechanisms comprise:
one or more control databases that include one or more images of one or more dissected insects.

19. The device of claim 1, wherein the one or more control units that are configured to control operation of the one or more drive mechanisms comprise:
one or more control databases that include one or more images of one or more dissected mosquitos.

20-29. (canceled)

30. The device of claim 1, wherein the one or more control units that are configured to control operation of the one or more drive mechanisms comprise:
one or more control units that are configured to process one or more images of one or more insects to produce one or more processed images and adjust operation of the one two or more drive mechanisms in response to the one or more processed images.

31-32. (canceled)

33. The device of claim 1, wherein the one or more control units that are configured to control operation of the one or more drive mechanisms comprise:
one or more control units that are configured to process one or more images of one or more mosquitos to produce one or more processed images and adjust operation of the one or more drive mechanisms in response to the one or more processed images.

34-39. (canceled)

40. The device of claim 1, further comprising:
one or more imaging apparatuses.

41. (canceled)

42. The device of claim 40, wherein the one or more imaging apparatuses comprise:
one or more cameras.

43. The device of claim 40, wherein the one or more imaging apparatuses comprise:
one or more machine vision cameras.

44-46. (canceled)

47. The device of claim 40, wherein the one or more imaging apparatuses comprise:
one or more imaging databases that include one or more images of one or more insects.

48. The device of claim 40, wherein the one or more imaging apparatuses comprise:
one or more imaging databases that include one or more images of one or more dissected insects.

49. The device of claim 40, wherein the one or more imaging apparatuses comprise:
one or more imaging databases that include one or more images of one or more dissected mosquitos.

50-57. (canceled)

58. The device of claim 40, wherein the one or more imaging apparatuses comprise:
one or more imaging apparatuses that are configured to process one or more acquired images of one or more insects to produce one or more processed images and then transmit one or more signals that instruct one or more control units to adjust operation of the one two or more drive mechanisms in response to the one or more processed images.

59-60. (canceled)

61. The device of claim 40, wherein the one or more imaging apparatuses comprise:
one or more imaging apparatuses that are configured to process one or more acquired images of one or more mosquitos to produce one or more processed images and then transmit one or more signals that instruct one or more control units to adjust operation of the one or more drive mechanisms in response to the one or more processed images.

62-67. (canceled)

68. A system comprising:
circuitry configured to acquire one or more images of one or more insects that are being dissected by one or more hydrodynamic shear forces within a fluid;
circuitry configured to analyze the one or more images of the one or more insects; and
circuitry configured to control one or more fluid propulsion modules in response to the circuitry configured to analyze the one or more images of the one or more insects.

69. The system of claim 68, wherein the circuitry configured to acquire one or more images of one or more insects that are being dissected by one or more hydrodynamic shear forces within a fluid comprises:
circuitry configured to control one or more image acquisition devices.

70. (canceled)

71. The system of claim 68, wherein the circuitry configured to acquire one or more images of one or more insects that are being dissected by one or more hydrodynamic shear forces within a fluid comprises:
circuitry configured to control one or more cameras.

72. The system of claim 68, wherein the circuitry configured to acquire one or more images of one or more insects that are being dissected by one or more hydrodynamic shear forces within a fluid comprises:
circuitry configured to control one or more machine vision cameras.

73. The system of claim 68, wherein the circuitry configured to analyze the one or more images of the one or more insects comprises:
one or more processors that are configured to analyze the one or more images of the one or more insects.

74. The system of claim 68, wherein the circuitry configured to analyze the one or more images of the one or more insects comprises:
circuitry configured to analyze one or more images of one or more mosquitos.

75-80. (canceled)

81. The system of claim 68, wherein the circuitry configured to analyze the one or more images of the one or more insects comprises:
circuitry configured to compare the one or more images of the one or more insects to one or more stored images of one or more insects of the same type.

82. (canceled)

83. The system of claim 68, wherein the circuitry configured to analyze the one or more images of the one or more insects comprises:
circuitry configured to determine if the one or more insects are dissected.

84-86. (canceled)

87. The system of claim 68, wherein the circuitry configured to analyze the one or more images of the one or more insects comprises:
circuitry configured to determine a percentage of insect thoraxes from which a head portion has been dissected.

88-91. (canceled)

92. The system of claim 68, wherein the circuitry configured to analyze the one or more images of the one or more insects comprises:
circuitry configured to determine a percentage of mosquito thoraxes from which a head portion has been dissected.

93. The system of claim 68, wherein the circuitry configured to control one or more fluid propulsion modules in response to the circuitry configured to analyze the one or more images of the one or more insects comprises:
circuitry configured to control one or more pumps.

94. (canceled)

95. The system of claim 68, wherein the circuitry configured to control one or more fluid propulsion modules in response to the circuitry configured to analyze the one or more images of the one or more insects comprises:
circuitry configured to control one or more motors.

96-97. (canceled)

98. The system of claim 68, wherein the circuitry configured to control one or more fluid propulsion modules in response to the circuitry configured to analyze the one or more images of the one or more insects comprises:
circuitry configured to control operation of the one or more fluid propulsion modules until the one or more insects are dissected to a predetermined level and then stop operation of the one or more fluid propulsion modules.

99. (canceled)

100. A computer program product comprising:
at least one non-transitory computer readable media including at least:
one or more instructions to acquire one or more images of one or more insects that are being dissected by one or more hydrodynamic shear forces within a fluid;
one or more instructions to analyze the one or more images of the one or more insects to produce an analysis of the one or more images of the one or more insects; and
one or more instructions to control one or more fluid propulsion modules in response to the analysis of the one or more images of the one or more insects.

101. (canceled)

102. The computer program product of claim 100, wherein the at least one non-transitory computer readable media includes a communications medium.

103-128. (canceled)
